(19) United States
(12) Patent Application Publication
(10) Pub. No.: US 2010/0069132 A1
(43) Pub. Date: Mar. 18, 2010

(54) STORAGE MEDIUM STORING PUZZLE GAME PROGRAM, PUZZLE GAME APPARATUS, AND PUZZLE GAME CONTROL METHOD

(75) Inventor: Yoshikazu Fujita, Tokyo (JP)

Correspondence Address: NIXON & VANDERHYE, P.C., 901 NORTH GLEBE ROAD, 11TH FLOOR, ARLINGTON, VA, 22203, US

(73) Assignees: NINTENDO CO., LTD., Kyoto (JP); SKIP LTD., Tokyo (JP)

(21) Appl. No.: 12/557,049

(22) Filed: Sep. 10, 2009

(30) Foreign Application Priority Data
Sep. 18, 2008 (JP) 2008-238896

(51) Int. Cl. A63F 9/24; A63F 13/00

(52) U.S. Cl. 463/9; 463/31

(57) ABSTRACT

A game apparatus includes a first LCD and a second LCD, and a game screen of a puzzle game, and the like are displayed on the first and second LCDs. Moreover, a touch panel is provided on a top surface of the second LCD. A player taps a stick on one of piece objects displayed on the second LCD to select a first piece object. Subsequently, the player drags the stick vertically or laterally to select a second piece object adjacent to the first piece object. As a result, arrangement positions of the selected two piece objects are interchanged, and numerals displayed on the respective piece objects are reversed laterally or vertically.

### CROSS REFERENCE OF RELATED APPLICATION

The disclosure of Japanese Patent Application No. 2008-238896 is incorporated herein by reference.

### BACKGROUND OF THE INVENTION

1. Field of the Invention

The present invention relates to a storage medium storing a puzzle game program, a puzzle game apparatus, and a puzzle game control method. Particularly, for example, the present invention relates to a storage medium storing a puzzle game program of erasing a plurality of piece objects arranged on a game field, a puzzle game apparatus, and a puzzle game control method.

2. Description of the Related Art

One example of the related art is disclosed in Japanese Patent Application Laid-Open No. 2001-038047 [A63F 13/00, A63F 13/10] (Document 1) laid-open on Feb. 13, 2001. Document 1 discloses the following puzzle game. That is, among various panel elements displayed on a stereoscopic game field, two panel elements are designated in accordance with manipulations by a player, and then are interchanged. Then, panel elements equal in type to one another are erased from the stereoscopic game field when being consecutively arranged in a predetermined direction by a predetermined number or more.

Moreover, another example of the related art is disclosed in Japanese Patent Application Laid-Open No. 2001-246152 [A63F 13/00, A63F 9/10] (Document 2) laid-open on Sep. 11, 2001. Document 2 discloses the following puzzle game. That is, various panels each having a line drawing connecting at least two connection terminals rendered thereon are arranged on a game field. Herein, two panels are designated in accordance with manipulations by a player, and then are interchanged. As a result, when a closed line drawing is completed, display indicative of the completion is effected.

In each of the techniques disclosed in Documents 1 and 2, however, arrangement positions of panels are interchanged simply. Consequently, a player can readily suppose arrangement (alignment) of interchanged panels. For this reason, there arises a problem that such a game tends to be monotony and a player loses interest in the game in a short time.

### SUMMARY OF THE INVENTION

Therefore, it is a primary object of the present invention to provide a novel storage medium storing a novel puzzle game program, a novel puzzle game apparatus, and a novel puzzle game control method.

Moreover, another object of the present invention is to provide a storage medium storing a puzzle game program that requires simple manipulations and gives complexity and fun to a player, a puzzle game apparatus, and a puzzle game control method.

The present invention employs following features in order to solve the above-described problems. It should be noted that reference numerals inside the parentheses and supplemental remarks show one example of a corresponding relationship with the embodiments described later for easy understanding of the present invention, and do not limit the present invention.

A first aspect of the present invention is directed to a storage medium storing a puzzle game program for a puzzle game apparatus including an inputting means. Herein, the puzzle game program allows a computer in the puzzle game apparatus to function as: an arranging means for arranging a plurality of piece objects on a game field; a selecting means for selecting at least one of the piece objects, based on an input from the inputting means; an arrangement position changing means for changing an arrangement position of at least one piece object selected by the selecting means, based on an input from the inputting means; a display form changing means for changing a display form of the piece object having the arrangement position changed by the arrangement position changing means, in accordance with a rule established in advance; and a condition determining means for determining whether all or part of the plurality of piece objects satisfy a predetermined condition when the display form changing means changes the display form of the piece object.

In the first aspect of the present invention, the puzzle game program allows the computer in the puzzle game apparatus (10) including the inputting means (22, 24) to function as the arranging means (34, S1), the selecting means (34, S47, S65), the arrangement position changing means (34, S71, S75, S79, S81), the display form changing means (34, S85), and the condition determining means (34, S117). The arranging means arranges a plurality of piece objects (106) on the game field (500). The selecting means selects at least one of the piece objects, based on an input from the inputting means. The arrangement position changing means changes an arrangement position of at least one piece object selected by the selecting means, based on an input from the inputting means. The display form changing means changes a display form of the piece object having the arrangement position changed by the arrangement position changing means, in accordance with the rule (748) established in advance. The condition determining means determines whether all or part of the plurality of piece objects satisfy the predetermined condition when the display form changing means changes the display form of the piece object.

According to the first aspect of the present invention, the display form of the piece object is changed in addition to the arrangement position of the piece object. Therefore, a player can not readily suppose arrangement of shifted piece objects, display forms of the piece objects, and the like. Accordingly, it is possible to realize a puzzle game that requires simple manipulations and gives complexity and fun to the player.

A second aspect of the present invention is dependent on the first aspect of the present invention. Herein, the puzzle game program further allows the computer to function as a piece erasing means for erasing all or part of the plurality of piece objects from the game field when the condition determining means determines that the predetermined condition is satisfied.

In the second aspect of the present invention, when the condition determining means determines that the predetermined condition is satisfied, the piece erasing means (34, S123) erases all or part of the plurality of piece objects each satisfying this predetermined condition, from the game field. That is, the piece object is erased from a game screen.

According to the second aspect of the present invention, the piece object satisfying the predetermined condition is erased. Therefore, the player can enjoy a sense of accomplishment, leading to increase of interest in the game.

A third aspect of the present invention is dependent on the first or second aspect of the present invention. Herein, the display form changing means changes the display form of the piece object having the arrangement position changed by the arrangement position changing means such that the display form after being subjected to the change is symmetrical to the display form before being subjected to the change.

In the third aspect of the present invention, the display form changing means changes the display form of the piece object having the arrangement position changed by the arrangement position changing means such that the display form after being subjected to the change is symmetrical to the display form before being subjected to the change. Accordingly, for example, in a case where a numeral or a letter is displayed on the piece object, when the arrangement position of the piece object is changed, the numeral or the letter is reversed laterally, is reversed vertically, or is reversed laterally and vertically.

According to the third aspect of the present invention, the display form of the piece object is changed based on a certain rule. Therefore, the player can play the game while thinking such a rule, leading to increase of interest in the game.

A fourth aspect of the present invention is dependent on the first to third aspects of the present invention. Herein, the arrangement position changing means interchanges arrangement positions of two piece objects selected by the selecting means.

In the fourth aspect of the present invention, the arrangement position changing means interchanges the arrangement positions of the two piece objects selected by the selecting means.

According to the fourth aspect of the present invention, a certain degree of restriction is imposed on the shift of the piece object, so that a level of difficulty about the game becomes higher as compared with a case where a piece object can be shifted freely. Accordingly, there is no possibility that the player loses interest in the game in a short time.

A fifth aspect of the present invention is dependent on the fourth aspect of the present invention. Herein, the inputting means includes a pointing device, and the selecting means selects a first piece object designated first and a second piece object designated subsequent to the first piece object, the second piece object being adjacent to the first piece object, by use of the pointing device.

In the fifth aspect of the present invention, the inputting means is a pointing device, for example. The selecting means selects the first piece object designated first and the second piece object designated subsequent to the first piece object, the second piece object being adjacent to the first piece object, by use of the pointing device. Thus, arrangement positions of the first and second piece objects are interchanged.

According to the fifth aspect of the present invention, the use of the pointing device allows intuitive and simple manipulations.

A sixth aspect of the present invention is dependent on the first to fifth aspects of the present invention. Herein, the puzzle game apparatus further includes a display form information table storing means for storing display form information table data about the display form of the piece object, and the display form changing means changes the display form of the piece object in accordance with the display form information table data stored in the display form information table storing means.

In the sixth aspect of the present invention, the puzzle game apparatus further includes the display form information table storing means (42, 74). The display form information table storing means stores the display form information table data (748) about the display form of the piece object. Accordingly, the display form changing means changes the display form of the piece object in accordance with the display form information table data stored in the display form information table storing means. That is, the rule established in advance is stored as a display form information table.

According to the sixth aspect of the present invention, the display form of the piece object is changed in accordance with the display form information table data. Therefore, this configuration allows alleviation of a processing load.

A seventh aspect of the present invention is dependent on the first to sixth aspects of the present invention. Herein, the piece object displays a numeral and a symbol that is symmetrical to the numeral, and the predetermined condition includes a case where a sum of numerals displayed on the plurality of piece objects is equal to a predetermined value.

In the seventh aspect of the present invention, the piece object displays a numeral and a symbol that is symmetrical to the numeral. Moreover, the predetermined condition includes the case where a sum of numerals displayed on the plurality of piece objects is equal to the predetermined value.

According to the seventh aspect of the present invention, the piece objects must be shifted such that a sum of numerals displayed thereon becomes equal to the predetermined value. Therefore, the player must think whether the sum becomes equal to the predetermined value, in addition to the display form of the piece object. Accordingly, this game requires high thinking power of the player, so that there is no possibility that the player loses interest in the game in a short time.

An eighth aspect of the present invention is dependent on the seventh aspect of the present invention. Herein, the puzzle game apparatus further includes an attribute table storing means for storing attribute table data indicating an attribute whether a numeral is displayed in accordance with the display form of the piece object, and the condition determining means determines whether a sum of numerals displayed on all or part of the plurality of piece objects is equal to the predetermined value, in accordance with the attribute table data stored in the attribute table storing means.

In the eighth aspect of the present invention, the puzzle game apparatus further includes the attribute table storing means (42, 74). The attribute table storing means stores the attribute table data indicating the attribute whether a numeral is displayed in accordance with the display form of the piece object. The condition determining means determines whether a sum of numerals displayed on all or part of the plurality of piece objects is equal to the predetermined value, in accordance with the attribute table data stored in the attribute table storing means.

According to the eighth aspect of the present invention, the attribute table data is stored. Therefore, determination is made whether a piece object displays a numeral only if necessary as in the case of the determination whether the sum is equal to the predetermined value. Accordingly, the number of processes to be executed can be reduced as compared with a case where determination is constantly made whether a piece object displays a numeral.

A ninth aspect of the present invention is directed to a puzzle game apparatus including: an inputting means; an arranging means for arranging a plurality of piece objects on a game field; a selecting means for selecting at least one of the piece objects, based on an input from the inputting means; an arrangement position changing means for changing an arrangement position of at least one piece object selected by the selecting means, based on an input from the inputting means; a display form changing means for changing a display form of the piece object having the arrangement position changed by the arrangement position changing means, in accordance with a rule established in advance; and a condition determining means for determining whether all or part of the plurality of piece objects satisfy a predetermined condition when the display form changing means changes the display form of the piece object.

According to the ninth aspect of the present invention, a player can play a puzzle game that requires simple manipulations and gives complexity and fun to the player, as in the first aspect of the present invention.

A tenth aspect of the present invention is directed to a puzzle game control method for a puzzle game apparatus including an inputting means. The puzzle game control method includes the steps of: (a) arranging a plurality of piece objects on a game field; (b) selecting at least one of the piece objects, based on an input from the inputting means; (c) changing an arrangement position of at least one piece object selected in the step (b), based on an input from the inputting means; (d) changing a display form of the piece object having the arrangement position changed in the step (c), in accordance with a rule established in advance; and (e) determining whether all or part of the plurality of piece objects satisfy a predetermined condition when the display form of the piece object is changed in the step (d).

According to the tenth aspect of the present invention, a player can play a puzzle game that requires simple manipulations and gives complexity and fun to the player, as in the first aspect of the present invention.

The above described objects and other objects, features and advantages of the present invention will become more apparent from the following detailed description of the present invention when taken in conjunction with the accompanying drawings.

### BRIEF DESCRIPTION OF THE DRAWINGS

FIG. 1 shows an illustrative view of a game apparatus according to one embodiment of the present invention;

FIG. 2 shows a block diagram of an electrical configuration of the game apparatus shown in FIG. 1;

FIG. 3 shows an illustrative view of a state of use in a case where a game is played using the game apparatus shown in FIG. 1;

FIG. 4 shows an illustrative view of one example of a game screen to be displayed on the game apparatus shown in FIG. 3;

FIG. 5 shows an illustrative view for illustrating a game field and a grid index of a puzzle game according to the embodiment;

FIG. 6 shows an illustrative view for illustrating a method for laterally turning a piece object in the puzzle game according to the embodiment;

FIG. 7 shows an illustrative view for illustrating a method for vertically turning a piece object in the puzzle game according to the embodiment;

FIG. 8 shows an illustrative view of a piece object in the puzzle game according to the embodiment and an example of change of a display form in a case of laterally turning a piece object;

FIG. 9 shows an illustrative view of an example of change of a display form in a case of vertically turning a piece object in the puzzle game according to the embodiment;

FIG. 10 shows an illustrative view of a second example of a game screen to be displayed on the game apparatus shown in FIG. 3;

FIG. 11 shows an illustrative view of a third example of a game screen to be displayed on the game apparatus shown in FIG. 3;

FIG. 12 shows an illustrative view of a fourth example of a game screen to be displayed on the game apparatus shown in FIG. 3;

FIG. 13 shows an illustrative view of a fifth example of a game screen to be displayed on the game apparatus shown in FIG. 3;

FIG. 14 shows an illustrative view of a sixth example of a game screen to be displayed on the game apparatus shown in FIG. 3;

FIG. 15 shows an illustrative view of a seventh example of a game screen to be displayed on the game apparatus shown in FIG. 3;

FIG. 16 shows an illustrative view of one example of a memory map in a RAM shown in FIG. 2;

FIG. 17 shows an illustrative view of details of a data memory area shown in FIG. 16;

FIG. 18 shows an illustrative view of a detailed example of a turn table provided by turn table data shown in FIG. 17;

FIG. 19 shows an illustrative view of a detailed example of an attribute table provided by attribute table data shown in FIG. 17 and a detailed example of a piece arrangement table provided by piece arrangement table data shown in FIG. 17;

FIG. 20 shows a flow chart of a main process to be executed by a CPU core shown in FIG. 2;

FIG. 21 shows a flow chart of part of a piece manipulation process to be executed by the CPU core shown in FIG. 2;

FIG. 22 shows a flow chart of another part of the piece manipulation process to be executed by the CPU core shown in FIG. 2, the flow chart following the flow chart shown in FIG. 21;

FIG. 23 shows a flow chart of still another part of the piece manipulation process to be executed by the CPU core shown in FIG. 2, the flow chart following the flow chart shown in FIG. 22;

FIG. 24 shows a flow chart of yet another part of the piece manipulation process to be executed by the CPU core shown in FIG. 2, the flow chart following the flow chart shown in FIG. 23;

FIG. 25 shows a flow chart of yet another part of the piece manipulation process to be executed by the CPU core shown in FIG. 2, the flow chart following the flow chart shown in FIG. 24;

FIG. 26 shows a flow chart of yet another part of the piece manipulation process to be executed by the CPU core shown in FIG. 2, the flow chart following the flow chart shown in FIG. 21;

FIG. 27 shows a flow chart of part of an erasure determination process to be executed by the CPU core shown in FIG. 2;

FIG. 28 shows a flow chart of another part of the erasure determination process to be executed by the CPU core shown in FIG. 2, the flow chart following the flow chart shown in FIG. 27; and

FIG. 29 shows a flow chart of a piece shift process to be executed by the CPU core shown in FIG. 2.

### DETAILED DESCRIPTION OF THE PREFERRED EMBODIMENTS

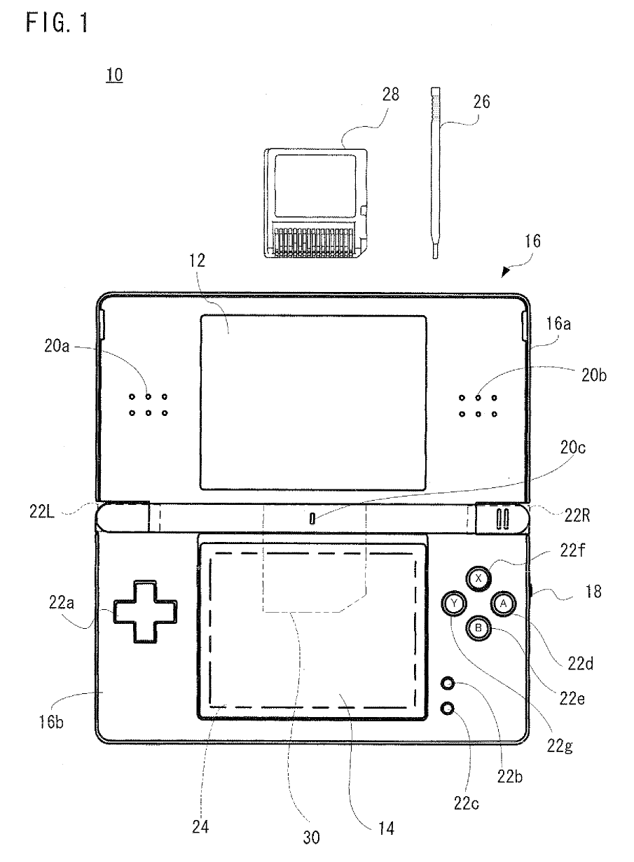

Referring to FIG. 1, a game apparatus 10 of an embodiment of this invention also functions as an image processing apparatus by storing an image processing program as described later. The game apparatus 10 includes a first liquid crystal display (LCD)12 and a second LCD 14. The LCD 12 and the LCD 14 are set on a housing 16 so as to be arranged in predetermined positions. In this embodiment, the housing 16 comprises an upper housing 16a and a lower housing 16b, and the LCD 12 is set on the upper housing 16a while the LCD 14 is set on the lower housing 16b. Accordingly, the LCD 12 and the LCD 14 are closely arranged so as to be longitudinally (vertically) parallel with each other.

In addition, although an LCD is utilized as a display in this embodiment, an EL (Electronic Luminescence) display, a plasmatic display, etc. may be used in place of the LCD.

As can be understood from FIG. 1, the upper housing 16a has a plane shape little larger than a plane shape of the LCD 12, and has an opening formed so as to expose a display surface of the LCD 12 from one main surface thereof. On the other hand, the lower housing 16b has a plane shape being approximately the same as the upper housing 16a, and has an opening formed so as to expose a display surface of the LCD 14 at an approximately center of the horizontal direction. On the left side of the LCD 14 of the lower housing 16b, a power switch 18 is provided.

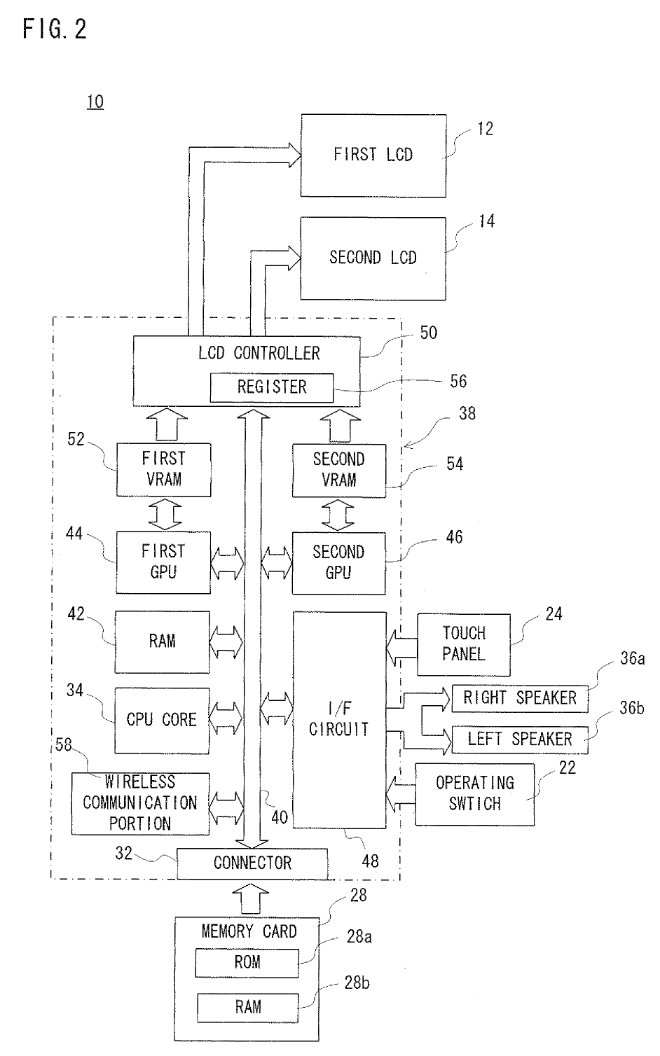

Furthermore, the upper housing 16a is provided with sound release holes 20a and 20b on both sides of the LCD 12 for speakers 36a and 36b (FIG. 2). The lower housing 16b is provided with a microphone hole 20c for a microphone (not illustrated) and operating switches 22 (22a, 22b, 22c, 22d, 22e, 22f, 22g, 22L and 22R).

In addition, the upper housing 16a and the lower housing 16b are rotatably connected at a lower side (lower edge) of the upper housing 16a and a part of an upper side (upper edge) of the lower housing 16b. Accordingly, in a case of not playing a game, for example, if the upper housing 16a is rotatably folded such that the display surface of the LCD 12 and the display surface of the LCD 14 are face to face with each other, it is possible to prevent the display surface of the LCD 12 and the display surface of the LCD 14 from being damaged such as a flaw, etc. It should be noted that the upper housing 16a and the lower housing 16b are not necessarily rotatably connected with each other, and may alternatively be provided integrally (fixedly) to form the housing 16.

The operating switch 22 includes a direction instructing switch (cross switch) 22a, a start switch 22b, a select switch 22c, an action switch (A button) 22d, an action switch (B button) 22e, an action switch (X button) 22f, an action switch (Y button) 22g, an action switch (L button) 22L, and an action switch (R button) 22R. The switch 22a is arranged at the left of the LCD 14 on one surface of the lower housing 16b. Other switches 22b-22g are arranged at the right of the LCD 14 on the one surface of the lower housing 16b. In addition, the switch 22L and the switch 22R are arranged at the right and left corners sandwiching the connected portion with the upper housing 16a on the upper side surface of the lower housing 16b.

The direction instructing switch 22a functions as a digital joystick, and is utilized for instructing a moving direction of a player character (or player object) to be operated by a user or a player and for instructing a moving direction of a cursor, and so forth by operating any one of four depression portions. Also, a specific role can be assigned to each of the four depression portions, and by operating any one of the four depression portions, it is possible to instruct (designate) the assigned role.

The start switch 22b is formed by a push button, and is utilized for starting (restarting), temporarily stopping (pausing) a game, and so forth. The select switch 22c is formed by the push button, and utilized for a game mode selection, etc.

The action switch 22d, that is, the A button is formed by the push button, and allows the player character to perform an arbitrary action, except for instructing the direction, such as hitting (punching), throwing, holding (obtaining), riding, jumping, etc. For example, in an action game, it is possible to apply an instruction of jumping, punching, moving arms, etc. In a role-playing game (RPG) and a simulation RPG, it is possible to apply an instruction of obtaining an item, selecting and determining arms or command, etc. The action switch 22e, that is, the B button is formed by the push button, and is utilized for changing a game mode selected by the select switch 22c, canceling an action determined by the A button 22d, and so forth.

The action switch 22f that is, the X button and the action switch 22g, that is, the Y button are formed by the push buttons, and are utilized for a subsidiary operation when the game cannot be advanced only with the A button 22d and the B button 22e. It should be noted that the X button 22f and the Y button 22g can be used for the similar operation to the A button 22d and B button 22e. Of course, the X button 22f and the Y button 22g are not necessarily utilized in the game play.

The action switch (left depression button) 22L and the action switch (right depression button) 22R are formed by the push button, and the left depression button (L button) 22L and the right depression button (R button) 22R can perform the same operation as the A button 22d and the B button 22e, and also function as a subsidiary of the A button 22d and the B button 22e. In addition, the L button 22L and the R button 22R can change the roles assigned to the direction switch 22a, the A button 22d, the B button 22e, the X button 22f, and the Y button 22g to other roles.

Also, on a top surface of the LCD 14, a touch panel 24 is provided. As the touch panel 24, any one of kinds of a resistance film system, an optical system (infrared rays system) and an electrostatic capacitive coupling system, for example, can be utilized. In response to an operation (touch operation) by depressing, stroking, touching, and so forth with a stick 26, a pen (stylus pen), or a finger (hereinafter, referred to as “stick 26, etc.”) on a top surface of the touch panel 24, the touch panel 24 detects coordinates of an operated position of the stick 26, etc. (that is, touched) to output coordinates data corresponding to the detected coordinates.

It should be noted that in this embodiment, a resolution of the display surface of the LCD 14 (the same is true for the LCD 12) is 256 dots×192 dots, and a detection accuracy of the touch panel 24 is also rendered 256 dots×192 dots in correspondence to the resolution of the display surface. However, the detection accuracy of the touch panel 24 may be lower than the resolution of the display surface, or higher than it.

Different game screens may be displayed on the LCD 12 and the LCD 14. For example, in a racing game, a screen viewed from a driving seat is displayed on the one LCD, and a screen of entire race (course) may be displayed on the other LCD. Furthermore, in the RPG, characters such as a map, a player character, etc. are displayed on the one LCD, and items belonging to the player character may be displayed on the other LCD. Additionally, a game play screen may be displayed on the one LCD (LCD 14 in this embodiment), and a game screen including information relating to the game (score, level, etc.) can be displayed on the other LCD (LCD 12 in this embodiment). Furthermore, by utilizing the two LCD 12 and LCD 14 as one screen, it is possible to display a large monster (enemy character) to be defeated by the player character.

Accordingly, the player is able to point (operate) an image such as a player character, an enemy character, an item character, an operating object, etc. to be displayed on the screen of the LCD 14 and select (input) commands by operating the touch panel 24 with the use of the stick 26, etc. Also, it is possible to change the direction of a virtual camera (viewpoint) (direction of the line of sight) provided in the three-dimensional game space, and instruct a scrolling (gradual moving display) direction of the game screen (map).

It should be noted that depending on the kind of the game, other input instructions can be made with the use of the touch panel 24, For example, it is possible to input a coordinates input instruction, and manually input letters, numbers, symbols, etc. on the LCD 14.

Thus, the game apparatus 10 has the LCD 12 and the LCD 14 as a display portion of two screens, and by providing the touch panel 24 on an upper surface of any one of them (LCD 14 in this embodiment), the game apparatus 10 has the two screens (12, 14) and the operating portions (22, 24) of two systems.

In addition, in this embodiment, the stick 26 can be housed in the housing portion (not illustrated) provided on the lower housing 16b, for example, and taken out as necessary. It should be noted that if the stick 26 is not provided, the housing portion also need not to be provided.

Also, the game apparatus 10 includes a memory card (or cartridge) 28. The memory card 28 is detachable, and inserted into a loading slot 30 (shown by dotted lines in FIG. 1) provided on a rear surface or a lower edge (bottom surface) of the lower housing 16b. Although omitted in FIG. 1, a connector 32 (see FIG. 2) is provided at a depth portion of the loading slot 30 for connecting a connector (not shown) provided at an end portion of the memory card 28 in the loading direction, and when the memory card 28 is loaded into the loading slot 30, the connectors are connected with each other to make the memory card 28 accessible by a CPU core 34 (see FIG. 2) of the game apparatus 10.

It should be noted that although not illustrated in FIG. 1, the speakers 36a and 36b (see FIG. 2) are provided at a position corresponding to the sound release holes 20a and 20b inside the upper housing 16a.

Furthermore although omitted in FIG. 1, for example, a battery accommodating box is provided on a rear surface of the lower housing 16b, and a volume switch, an external expansion connector, an earphone jack, etc. are provided on a bottom surface of the lower housing 16b.

FIG. 2 is a block diagram showing an electrical configuration of the game apparatus 10. Referring to FIG. 2, the game apparatus 10 includes an electronic circuit board 38, and on the electronic circuit board 38, a circuit component such as the CPU core 34, etc. is mounted. The CPU core 34 is connected to the above-described connectors 32 via a bus 40, and is connected with a RAM 42, a first graphics processing unit (GPU) 44, a second GPU 46, an input-output interface circuit (hereinafter, referred to as “I/F circuit”) 48, and an LCD controller 50.

The connector 32 is detachably connected with the memory card 28 as described above. The memory card 28 includes a ROM 28a and a RAM 28b, and although illustration is omitted, the ROM 28a and the RAM 28b are connected with each other via a bus and also connected with a connector (not shown) to be connected with the connector 32. Accordingly, the CPU core 34 gains access to the ROM 28a and the RAM 28b as described above.

The ROM 28a stores in advance a game program for a game to be executed by the game apparatus 10, image data (text and object image, background image, item image, icon (button) image, message image, etc.), data of the sound (music) necessary for the game (sound data), etc. The RAM (backup RAM) 28b stores (saves) proceeding data of the game, result data of the game, etc.

The RAM 42 is utilized as a buffer memory or a working memory. That is, the CPU core 34 loads the game program, the image data, the sound data, etc. stored in the ROM 28a of the memory card 28 into the RAM 42, and executes the loaded game program. The CPU core 34 executes a game process while storing data (game data, flag data, etc.) generated or obtained in correspondence with a progress of the game in the RAM 42.

It should be noted that the game program, the image data, the sound data, etc. are stored (loaded) from the ROM 28a entirely at a time, or partially and sequentially so as to be stored into the RAM 42.

However, a program as to an application except for the game and image data required to execute the application may be stored in the ROM 28a of the memory card 28. In addition, sound (music) data may be stored therein as necessary. In such a case, in the game apparatus 10, the application is executed.

Each of the CPU 44 and the GPU 46 forms a part of a rendering means, is constructed by, for example, a single chip ASIC, and receives a graphics command (rendering command) from the CPU core 34 to generate image data according to the graphics command. Additionally, the CPU core 34 applies an image generation program (included in the game program) required to generate the image data to both of the GPU 44 and GPU 46 in addition to the graphics command.

Furthermore, the GPU 44 is connected with a first video RAM (hereinafter referred to as “VRAM”) 52, and the GPU 46 is connected with a second VRAM 54. The CPU 44 and the GPU 46 respectively access the first VRAM 52 and the second VRAM 54 to obtain data (image data: polygon data, texture data, etc.) required to execute the rendering command.

It should be noted that the CPU core 34 writes image data necessary for rendering to the first VRAM 52 and the second VRAM 54 via the GPU 44 and the GPU 46. The GPU 44 accesses the VRAM 52 to create image data for rendering, and the GPU 46 accesses the VRAM 54 to create image data for rendering.

The VRAM 52 and the VRAM 54 are connected to the LCD controller 50. The LCD controller 50 includes a register 56, and the register 56 consists of, for example, one bit, and stores a value of “0”, or “1” (data value) according to an instruction of the CPU core 34. The LCD controller 50 outputs the image data created by the GPU 44 to the LCD 12, and outputs the image data created by the GPU 46 to the LCD 14 in a case that the data value of the register 56 is “0”. Additionally, the LCD controller 50 outputs the image data created by the GPU 44 to the LCD 14, and outputs the image data created by the GPU 46 to the LCD 12 in a case that the data value of the register 56 is “1”.

Here, the LCD controller 50 can directly read the image data from the VRAM 52 and the VRAM 54, or read the image data from the VRAM 52 and the VRAM 54 via the GPU 44 and the GPU 46.

The I/F circuit 48 is connected with the operating switch 22, the touch panel 24 and the speakers 36a, 36b. Here, the operating switch 22 is the above-described switches 22a, 22b, 22c, 22d, 22e, 22f, 22g, 22L and 22R, and in response to an operation of the operating switch 22, a corresponding operation signal (operation data) is input to the CPU core 34 via the I/F circuit 48. Furthermore, coordinates data output from the touch panel 24 is input to the CPU core 34 via the I/F circuit 48. In addition, the CPU core 34 reads from the RAM 42 the sound data necessary for the game, such as a game music (BGM), a sound effect or voices of a game character (onomatopoeic sound), etc., and outputs the same from the speakers 36a, 36b via the I/F circuit 48.

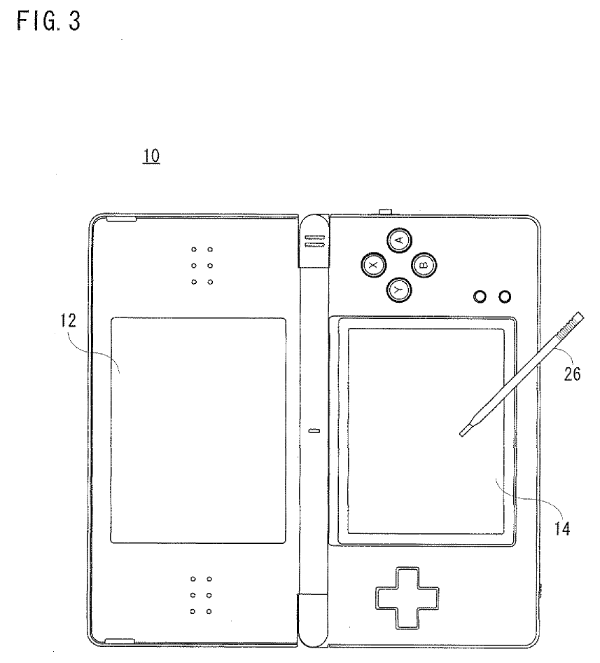

FIG. 3 is an illustrative view showing a usage example of the game apparatus 10 shown in FIG. 1 when a virtual game in this embodiment is played. As understood from FIG. 3, in this embodiment, the game apparatus 10 is used in a state it is turned from the state shown in FIG. 1 counterclockwise (to the left) at 90 degrees. Accordingly, the LCD 12 and the LCD 14 (touch panel 24) are arranged side by side. In this embodiment, a game field formed on a three-dimensional virtual space is displayed using one screen (a game screen) as a combination of the LCD 12 and the LCD 14.

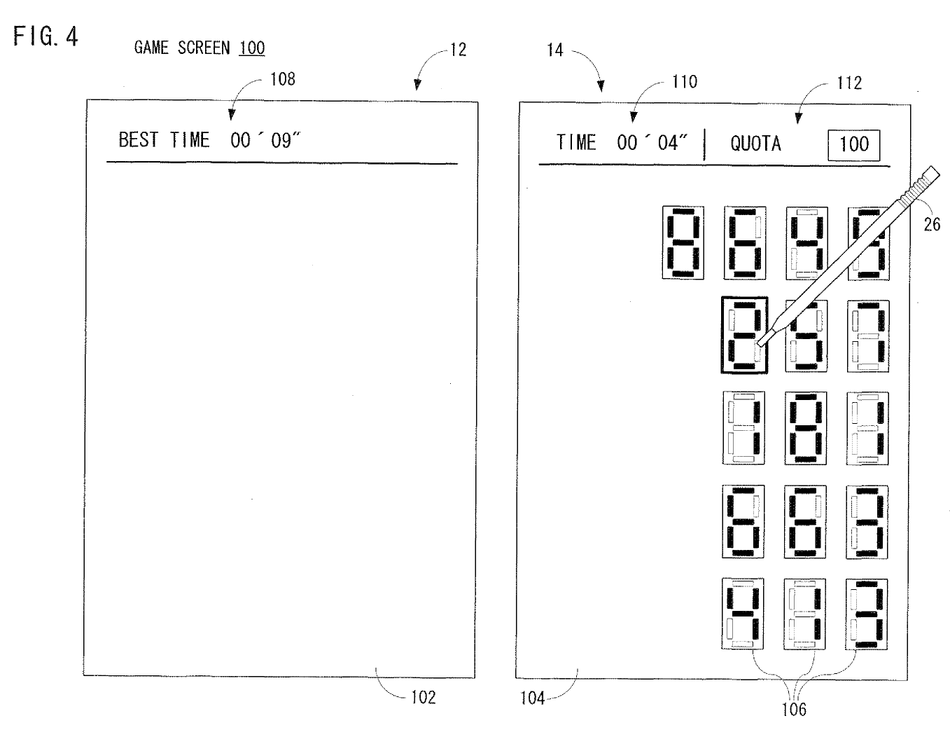

FIG. 4 shows an example of a game screen 100 displayed on the LCDs 12 and 14 in a case of playing a virtual game (a puzzle game) according to this embodiment. The game screen 100 is configured with a display screen 102 of the LCD 12 and a display screen 104 of the LCD 14. On the display screen 104, moreover, a plurality of piece objects 106 are arranged in a matrix form. Each piece object 106 has a rectangular plate shape. In order to facilitate understanding of a shape and a size of such a piece object 106, the piece object 106 shown in FIG. 4 is surrounded with an outer frame. However, the piece object 106 itself is colorless and transparent. Herein, the piece object 106 may be displayed with a color equal to or different from a background color. In this embodiment, each of the display screens 102 and 104 can display five piece objects 106 at maximum in a vertical direction and six piece objects 106 at maximum in a lateral direction. In other words, 60 (5 in one row×12 in one column) piece objects 106 can be displayed at maximum on the game field.

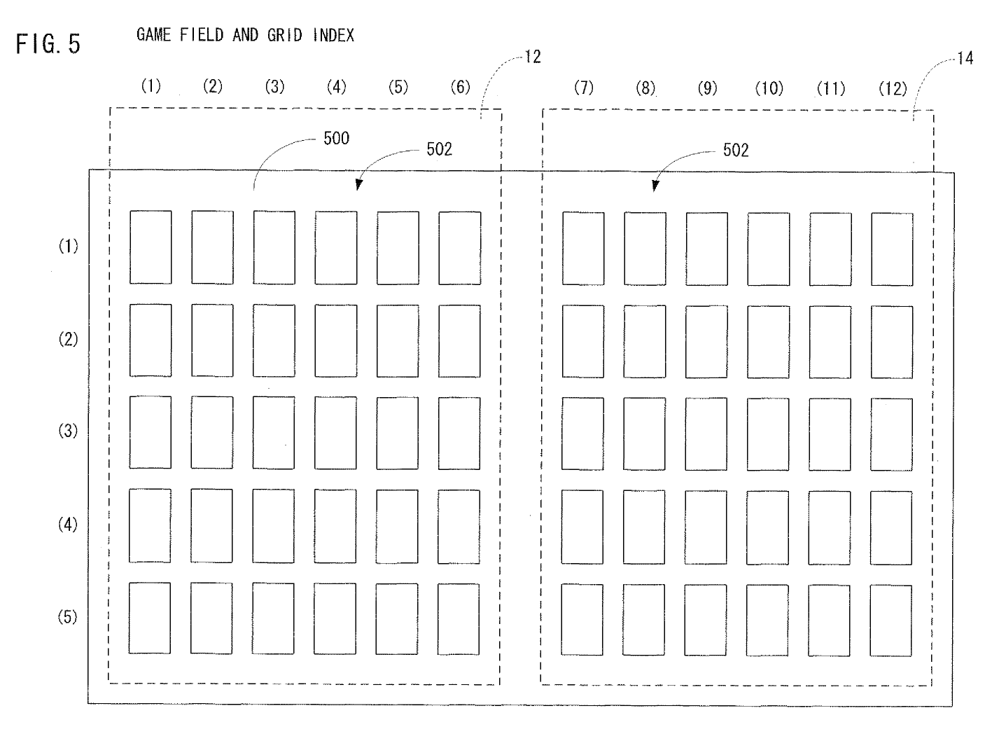

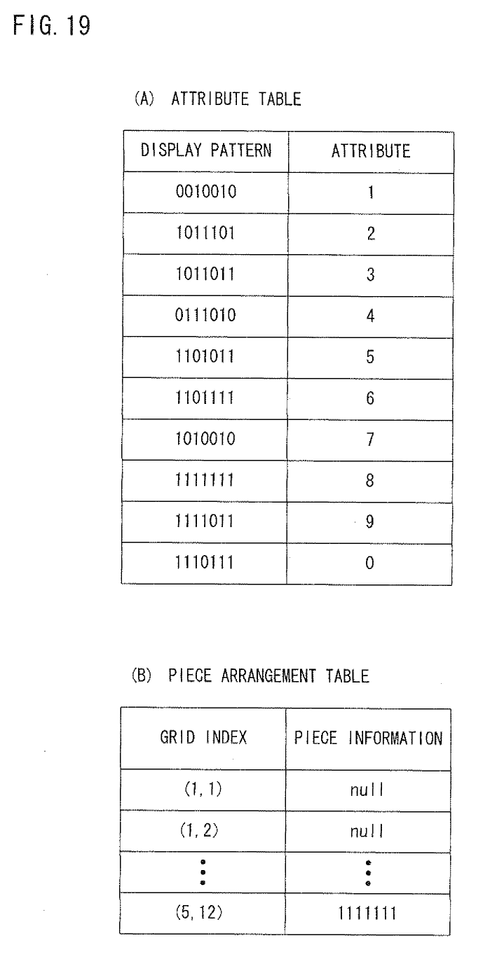

FIG. 5 shows a two-dimensional planar game field 500 formed on the three-dimensional virtual space, and the game field 500 is partly displayed as a game screen on the LCDs 12 and 14. On the game field 500, a plurality (5×12) of grids 502 are arranged in a matrix form. In order to facilitate understanding, FIG. 5 visibly shows each grid 502. However, the grid 502 is an invisible object and, therefore, is not displayed on the actual game screen (see FIG. 4 and the like). Each grid 502 has identification information (a grid index) allocated thereto, and a type of a piece object 106 held in the grid 502 is managed using the grid index in an identifiable manner (see FIG. 19(B): a piece arrangement table to be described later). For example, the grid index is represented by a set of a row number and a column number as parenthesized numerals. More specifically, the grid 502 located at an upper left corner has a grid index of (1, 1) whereas the grid 502 located at a lower right corner has a grid index of (5, 12). The same things hold true for grid indexes of the remaining grids 502; therefore, detailed description thereof will not be given here.

In a case where a grid 502 holds no piece object 106, information indicating a fact that the grid 502 holds nothing (e.g., “null”) is managed (stored) in correspondence with a grid index of the grid 502.

With reference to FIG. 4 again, a display part 108 that displays a best score is provided on an upper side of the display screen 102 in the game screen 100. Further, a display part 110 that displays a time (a time elapsed from a start of the game) and a display part 112 that displays a quota are provided on an upper side of the display screen 104 in the game screen 100.

In the puzzle game according to this embodiment, when a piece object 106 is shifted, a display form of the shifted piece object 106 is changed in accordance with the shift. Specifically, a numeral or a symbol displayed on the piece object 106 is reversed laterally or vertically. A player selects a range where two or more piece objects 106 are aligned vertically or laterally. When a sum of numerals displayed on the two or more piece objects 106 in the selected range is equal to a predetermined value (e.g., 10), the two or more piece objects 106 are erased from the game field 500. Herein, when a piece object 106 is erased or a predetermined time is elapsed, a new piece object 106 is supplied to the game field 500. The game is complete when piece objects 106 are erased within a limited time by a number set as a quota. On the other hand, the game is over if the limited time is elapsed or piece objects 106 are held in all the grids 502 (are displayed on the entire display screens 102 and 104) on the game field 500 before piece objects 106 are erased by the number set as the quota. Hereinafter, detailed description will be given of the puzzle game according to this embodiment.

When the game is started, the LCDs 12 and 14 display an initial game screen (an initial screen) (not shown). For example, 15 (5 in one row×3 in one column) piece objects 106 are displayed on the initial screen. Herein, all the piece objects 106 are displayed at a right end of the initial screen (the LCD 14) in a state of a cluster.

The player designates a desired one of the piece objects 106 through the stick 26 or the like, and shifts the piece object 106 in the display screen 104. In this embodiment, the player designates two piece objects 106 adjacent to each other in a vertical direction or a lateral direction. The respective piece objects 106 selected in accordance with the designation are shifted such that arrangement positions thereof are interchanged.

Although not shown clearly in the drawings, in order to select a desired one of the piece objects 106, the player designates (touch-on, tap) the relevant piece object 106 in a touch-off state (a release state). In FIG. 4, a piece object 106 selected in accordance with designation by the player is surrounded with a bold line frame. Herein, the selected piece object 106 may be surrounded with a color line frame, may be entirely highlighted in color, or may be emphasized in color or brightness. Alternatively, a certain pointing image (a marker) may be displayed forward of the selected piece object 106. That is, the selected piece object 106 is displayed in an identifiable manner. Thus, the player fixes the piece object 106 selected first (hereinafter, occasionally referred to as “a first piece object 106” for convenience of the description).

In the actual puzzle game, as will be described later, in a case where a first piece object 106 and a second piece object 106 are selected and then a process of turning these piece objects is executed and in a case where a piece object 106 is selected as a starting point of an erasure range, such a selected piece object 106 is surrounded with a bold line frame.

Subsequent to the selection of the first piece object 106, the player drags (slides) the stick 26 or the like on the touch panel 24 and then taps the stick 26 or the like on a piece object 106 adjacent upward, downward, leftward or rightward to the first piece object 106. Thus, the player fixes the piece object 106 selected second (hereinafter, occasionally referred to as “a second piece object 106” for convenience of the description).

When two piece objects 106 are selected as described above, arrangement positions thereof are interchanged. In this embodiment, as described above, the two-dimensional game field 500 is formed on the three-dimensional virtual space. As described above, moreover, when a piece object 106 is shifted, a display form thereof is changed such that the piece object 106 is reversed laterally or vertically. In this embodiment, accordingly, the first piece object 106 and the second piece object 106 are turned by 180° about an axis assumed therebetween, so that the arrangement positions thereof are interchanged. Herein, each of the first and second piece objects 106 is reversed; therefore, the display form thereof is also reversed laterally or vertically in accordance with a direction of the turn.

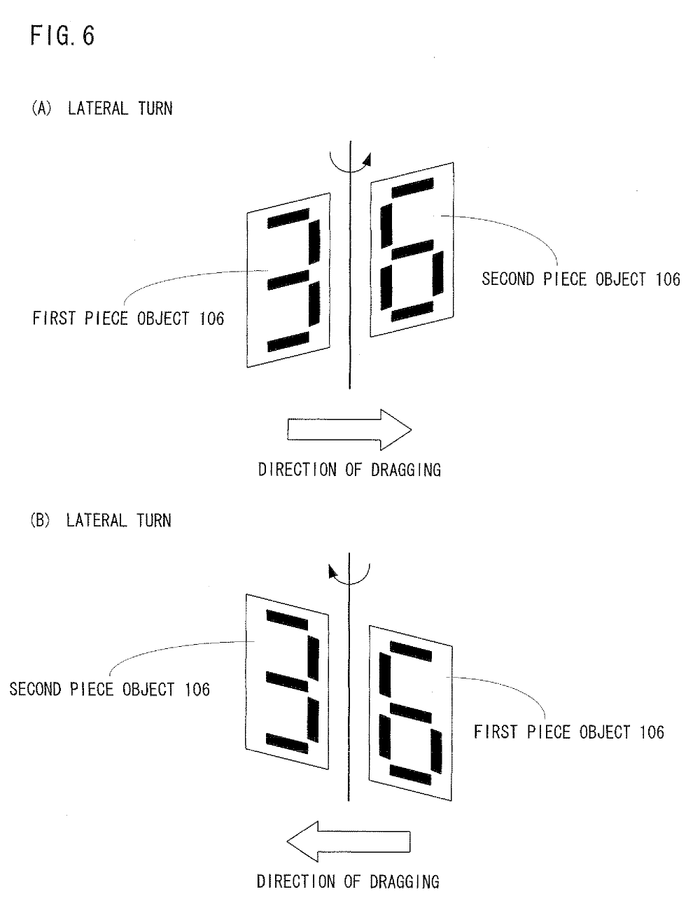

More specifically, a first piece object 106 and a second piece object 106 are turned laterally when being arranged laterally. As shown in FIG. 6(A), it is assumed that the first piece object 106 is on a left side whereas the second piece object 106 is on a right side. In such a case, the first piece object 106 is turned so as to shift from left to right via a forward side (a viewpoint side) when being seen from the player whereas the second piece object 106 is turned so as to shift from right to left via a backward side when being seen from the player. Herein, each piece object 106 is turned by 180° about an axis of rotation (a vertical axis). In the following, the same things hold true for a case of turning a piece object 106.

For example, when the player taps the stick 26 on the left piece object 106 and then drags the stick 26 rightward, the left piece object 106 is selected as a first piece object whereas the right piece object 106 is selected as a second piece object.

As shown in FIG. 6(B), moreover, it is assumed that the first piece object 106 is on the right side whereas the second piece object 106 is on the left side. In such a case, the first piece object 106 is turned so as to shift from right to left via the forward side (the viewpoint side) when being seen from the player whereas the second piece object 106 is turned so as to shift from left to right via the backward side when being seen from the player.

For example, when the player taps the stick 26 on the right piece object 106 and then drags the stick 26 leftward, the right piece object 106 is selected as a first piece object whereas the left piece object 106 is selected as a second piece object.

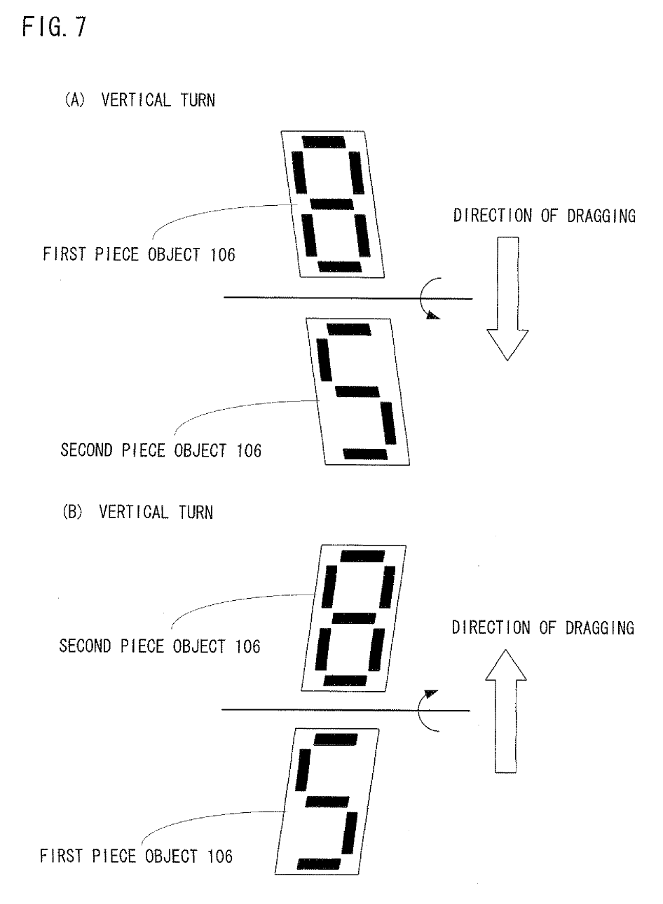

On the other hand, a first piece object 106 and a second piece object 106 are turned vertically when being arranged vertically. As shown in FIG. 7(A), it is assumed that the first piece object 106 is on an upper side whereas the second piece object 106 is on a lower side. In such a case, the first piece object 106 is turned so as to shift from top to bottom via the forward side (the viewpoint side) when being seen from the player whereas the second piece object 106 is turned so as to shift from bottom to top via the backward side when being seen from the player.

For example, when the player taps the stick 26 on the upper piece object 106 and then drags the stick 26 downward, the upper piece object 106 is selected as a first piece object whereas the lower piece object 106 is selected as a second piece object.

As shown in FIG. 7(B), moreover, it is assumed that the first piece object 106 is on the lower side whereas the second piece object 106 is on the upper side. In such a case, the first piece object 106 is turned so as to shift from bottom to top via the forward side (the viewpoint side) when being seen from the player whereas the second piece object 106 is turned so as to shift from top to bottom via the backward side when being seen from the player.

For example, when the player taps the stick 26 on the lower piece object 106 and then drags the stick 26 upward, the lower piece object 106 is selected as a first piece object whereas the upper piece object 106 is selected as a second piece object.

In order to facilitate understanding of the direction of turn of the piece object 106, each of the piece objects 106 shown in FIGS. 6 and 7 is slanted slightly. In actual, however, the piece object 106 is not slanted.

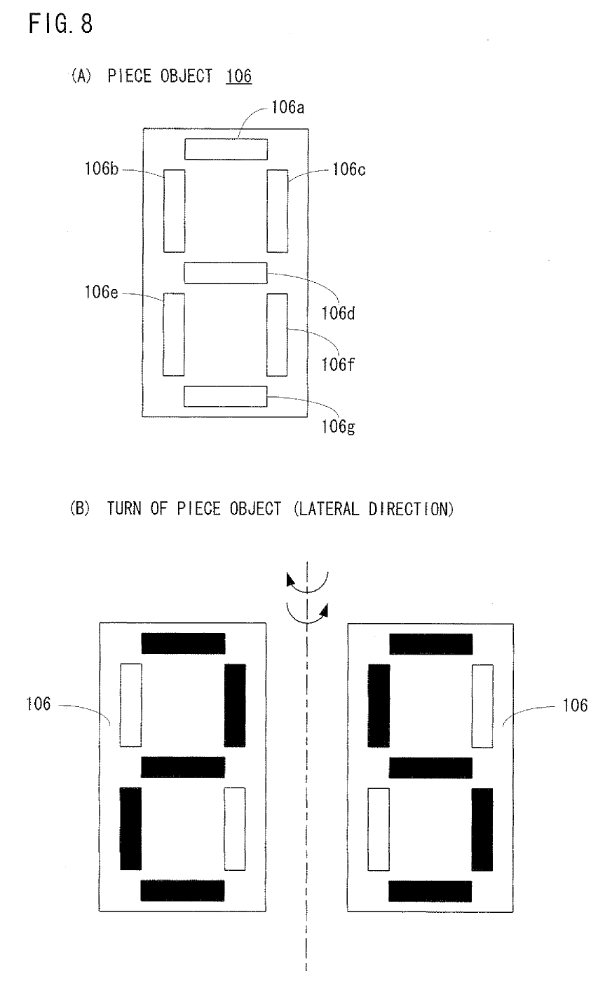

In this embodiment, as shown in FIG. 8(A), a numeral or a symbol symmetrical to the numeral with respect to a line or a point is displayed on a top surface (a surface on the viewpoint side) of a piece object 106 by seven-segment display. In this embodiment, all segments 106a, 106b, 106c, 106d, 106e, 106f and 106g are displayed on a top surface of a piece object 106. In actual, however, only some of segments 106a to 106g for displaying a numeral or a symbol are rendered. Accordingly, as described above, when a piece object 106 is turned by 180° (in a lateral direction or a vertical direction), a numeral or a symbol displayed thereon is also turned by 180°. That is, a display form of the piece object 106 is changed.

In this embodiment, a numeral or a symbol is rendered by seven-segment display on a top surface of a piece object 106. Therefore, when the piece object 106 is reversed in a process of turning the piece object 106, a numeral or a symbol, which is reversed laterally or vertically, is newly rendered on the top surface of the piece object 106.

As shown in FIG. 8(B), for example, when a piece object 106 that displays a numeral “2” is laterally turned by 180°, the numeral “2” displayed on the piece object 106 is changed to a numeral “5”. On the other hand, when a piece object 106 that displays a numeral “5” is laterally turned by 180°, the numeral “5” displayed on the piece object 106 is changed to a numeral “2”. As described above, a numeral or a symbol displayed on a piece object 106 before being turned laterally is symmetrical to a numeral or a symbol to be displayed on the piece object 106 after being turned laterally, with respect to a line about a vertical axis.

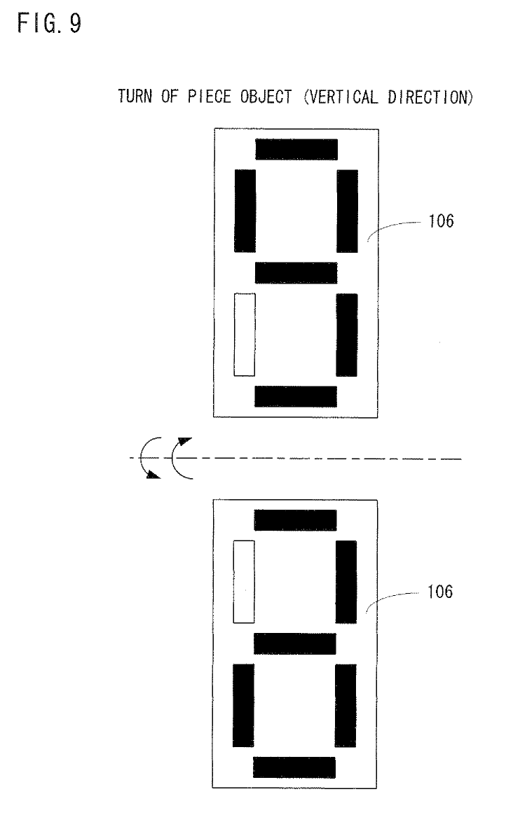

As shown in FIG. 9, moreover, when a piece object 106 that displays a numeral “9” is vertically turned by 180°, the numeral “9” displayed on the piece object 106 is changed to a symbol corresponding to the numeral “9” reversed vertically (a symbol corresponding to a numeral “6” reversed laterally). On the other hand, a piece object 106 that displays a symbol corresponding to a numeral “9” reversed vertically (a symbol corresponding to a numeral “6” reversed laterally) is vertically turned by 180°, the symbol displayed on the piece object 106 is changed to a numeral “9”. As described above, a numeral or a symbol displayed on a piece object 106 before being turned vertically is symmetrical to a numerical or a symbol to be displayed on the piece object 106 after being turned vertically, with respect to a line about a lateral axis.

The same things hold true for the remaining numerals; therefore, detailed description thereof with reference to the drawings will not be given here. Even when a laterally and vertically symmetrical numeral such as “0” or “8” is reversed laterally or vertically, a display form thereof is not changed. Moreover, even when a vertically symmetrical numeral such as “1” or “3” is reversed vertically, a display form thereof is not changed. However, when being reversed laterally, the numeral “1” is changed to a symbol corresponding to the numeral “1” reversed laterally whereas the numeral “3” is changed to a symbol corresponding to the numeral “3” reversed laterally. Herein, the numeral “1” can be recognized as a numeral “1” even when being reversed laterally; however, segments to be used for displaying the numeral “1” (a display pattern to be described later) are changed. In this embodiment, therefore, when being reversed laterally, the numeral “1” is changed to a symbol corresponding to the numeral “1” reversed laterally.

Although not shown in the drawings, it is assumed herein that a piece object 106 is reversed laterally or vertically and, further, is reversed vertically or laterally. In such a case, the piece object 106 is shifted diagonally from its original position (a grid 502). Herein, a numeral or a symbol displayed on the piece object 106 before the shift is symmetrical to a numeral or a symbol to be displayed on the piece object 106 after the shift, with respect to a point.

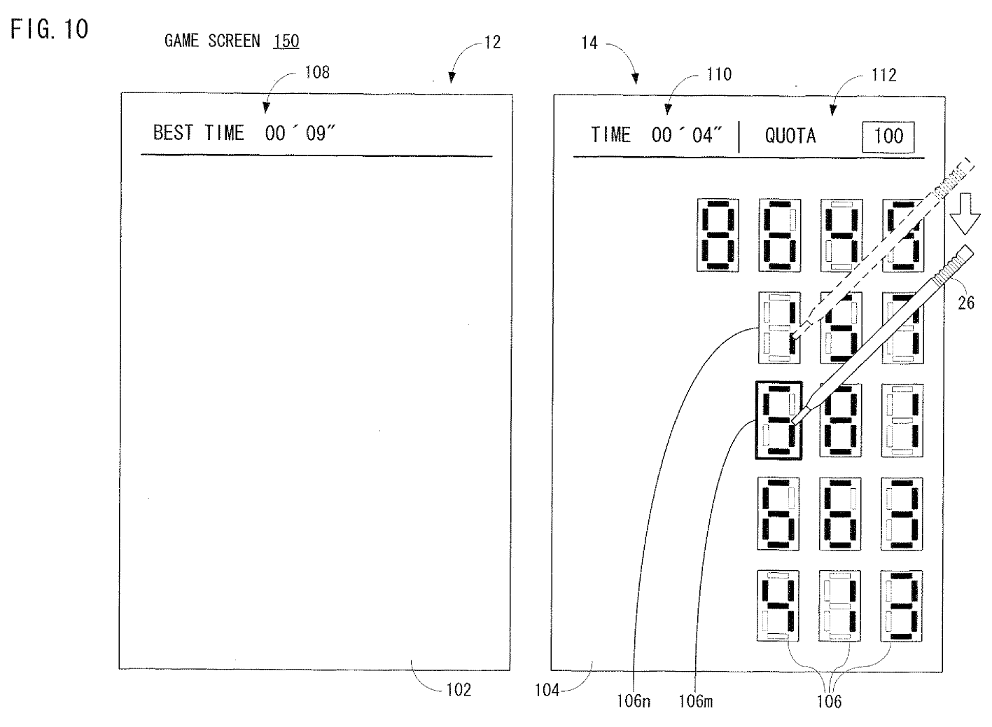

In the state shown in FIG. 4, for example, when the player selects a first piece object 106 and then drags the stick 26 downward to select a second piece object 106, the first piece object 106 (hereinafter, referred to as “a first piece object 106m” for convenience of the description) and the second piece object 106 (hereinafter, referred to as “a second piece object 106n” for convenience of the description) are turned vertically as shown in a game screen 150 of FIG. 10. Thus, an arrangement position of the first piece object 106m and that of the second piece object 106n are interchanged. Further, a display form of the first piece object 106m and that of the second piece object 106n are changed. Specifically, the first piece object 106m that displays a numeral “2” is shifted to an immediately downward grid 502 while being reversed vertically, so that the numeral “2” displayed on a top surface thereof is changed to a numeral “5”. On the other hand, the second piece object 106n that displays a numeral “1” is shifted to an immediately upward grid 502 while being reversed vertically; however, the numeral “1” displayed on a top surface thereof is not changed.

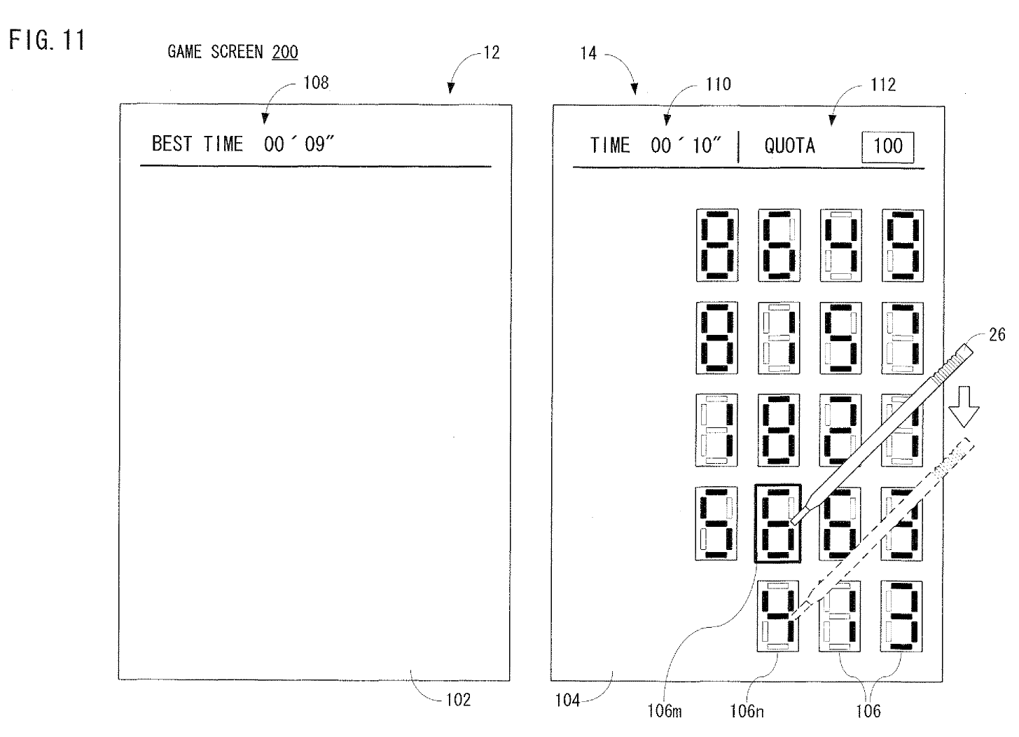

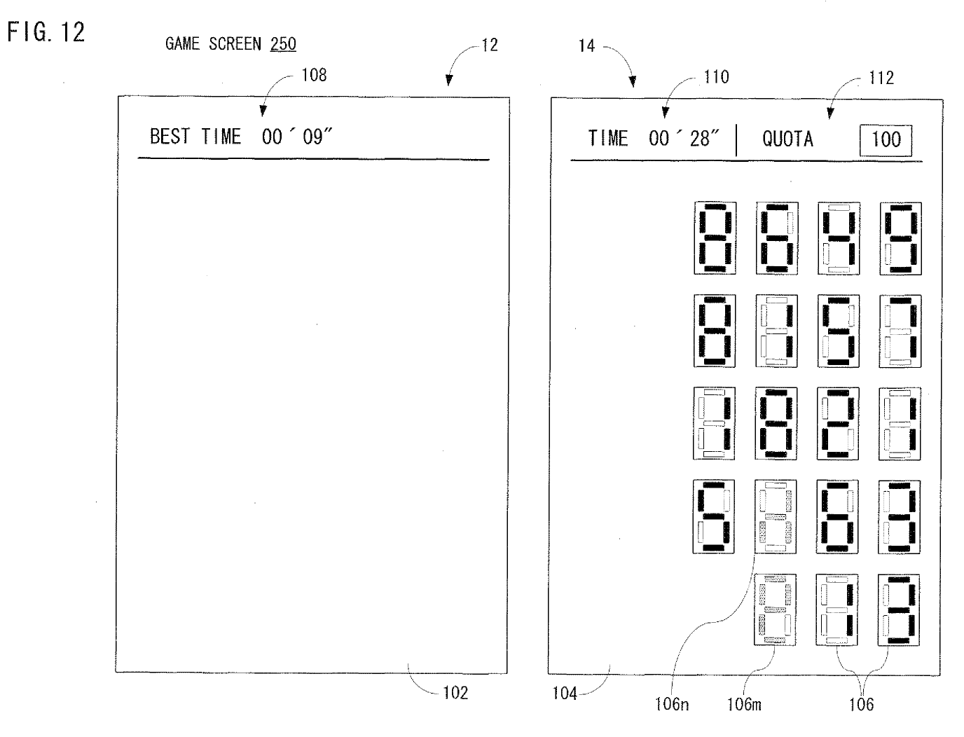

In a different game screen 200 shown in FIG. 11, moreover, the player taps the stick 26 on a first piece object 106m that displays a numeral “6” and then drags the stick 26 downward to select as a second piece object 106n a piece object 106 located on an immediately downward side of the first piece object 106m. As shown in a game screen 250 of FIG. 12, thus, the first piece object 106m that displays the numeral “6” is shifted to an immediately downward grid 502 while being reversed vertically, so that the numeral “6” displayed on a top surface thereof is changed to a symbol corresponding to the numeral “6” reversed vertically (a symbol corresponding to a numeral “9” reversed laterally). On the other hand, the second piece object 106n that displays a numeral “4,” is shifted to an immediately upward grid 502 while being reversed vertically, so that the numeral “4” displayed on a top surface thereof is changed to a symbol corresponding to the numeral “4” reversed vertically.

In this embodiment, as shown in FIG. 12, when a piece object 106 displays a symbol rather than a numeral, the symbol is displayed in a gray out manner in order to facilitate discrimination of a numeral from a symbol. Accordingly, such a symbol is not necessarily displayed in a gray out manner as in a numeral.

Moreover, a game screen in a case of lateral dragging is not shown in the drawings because it is equal to that in the case of vertical dragging except a direction of shift and a direction of reverse of a piece object 106.

As described above, arrangement positions of two piece objects 106 are interchanged by lateral or vertical dragging, so that a desired piece object 106 can be shifted. In the puzzle game, as described above, when a sum of numerals displayed on two or more piece objects 106 arranged vertically or laterally becomes equal to a predetermined value, the two or more piece objects 106 can be erased from the game screen. Among the two or more piece objects 106, the player independently designates (selects) two piece objects 106 located on both ends (a starting point and an endpoint). Thus, the player designates the two or more piece objects 106 to be erased (i.e., an erasure range).

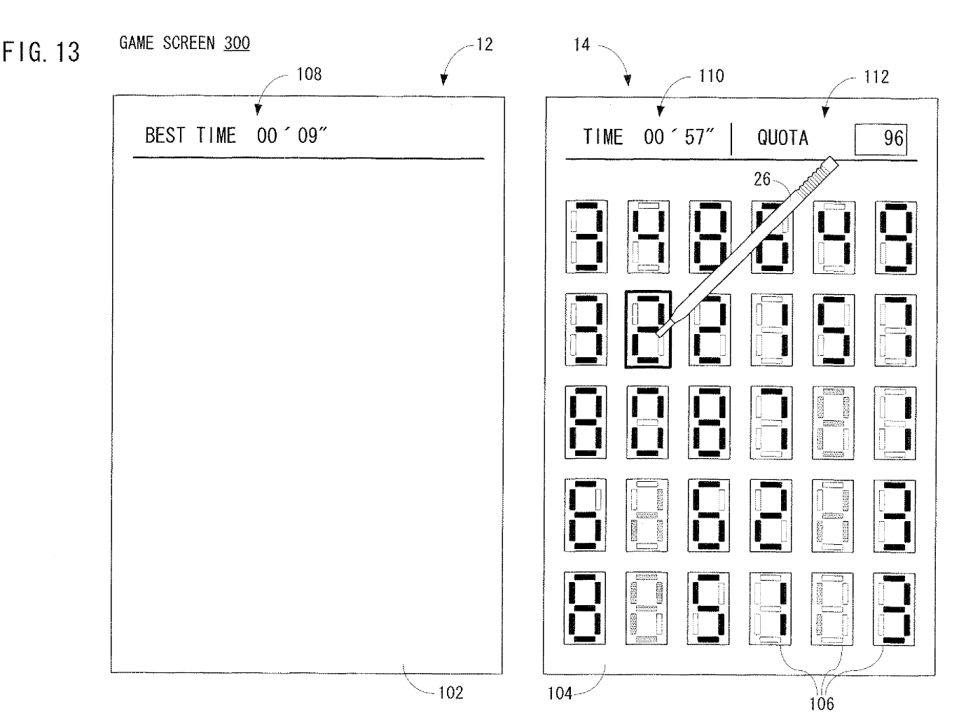

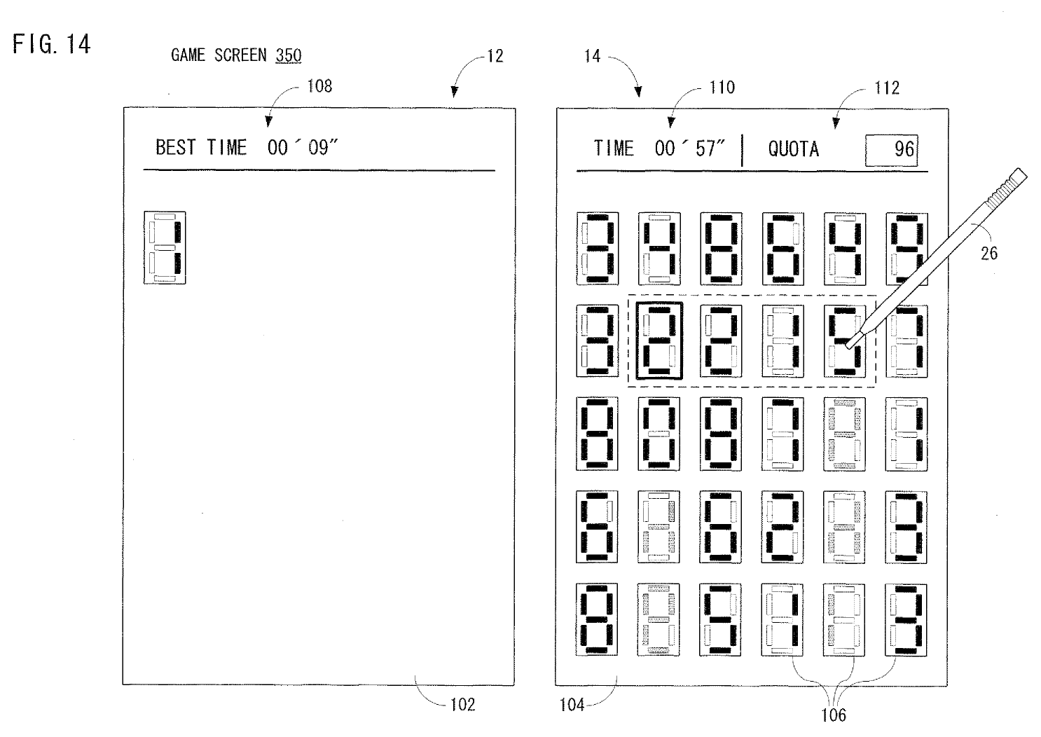

For example, the player selects a piece object 106 on one end (a starting point) as shown in a game screen 300 of FIG. 13, and then selects a piece object 106 on the other end (an endpoint) as shown in a game screen 350 of FIG. 14. In this embodiment, however, dragging of the selected piece object 106 on the starting point changes an arrangement position and a display form of the piece object 106. In order to designate an erasure range, therefore, the player independently touches (tap) the piece objects 106 on the two ends of the erasure range.

In FIG. 14, a plurality of piece objects 106 in an erasure range designated by the player are surrounded with a dotted frame.

Such an erasure range is designated using two or more piece objects 106 aligned vertically or laterally. For this reason, the erasure range is not designated in a case where selected two piece objects 106 are not aligned. That is, the designation of the erasure range results in failure. In this embodiment, as will be described later, it is determined whether a sum of numerals displayed on all the piece objects 106 in the erasure range is equal to a predetermined value. For this reason, there is a necessity that all the piece objects 106 in the erasure range display numerals, respectively. Accordingly, the designation of the erasure range also results in failure in a case where a piece object 106 that displays a symbol corresponding to a numeral reversed laterally or vertically is in the erasure range. When the designation of the erasure range results in failure, the piece object 106 (on the other end) designated finally is selected as a first piece object 106m or a piece object 106 on a starting point for designating a different erasure range.

When two piece objects 106 on a starting point and an endpoint of an erasure range are selected, a sum of numerals displayed on these piece objects 106 and piece objects 106 interposed therebetween is calculated. That is, a sum of numerals displayed on piece objects 106 on a straight line connecting between the two ends is calculated. Then, it is determined whether the sum is a predetermined value.

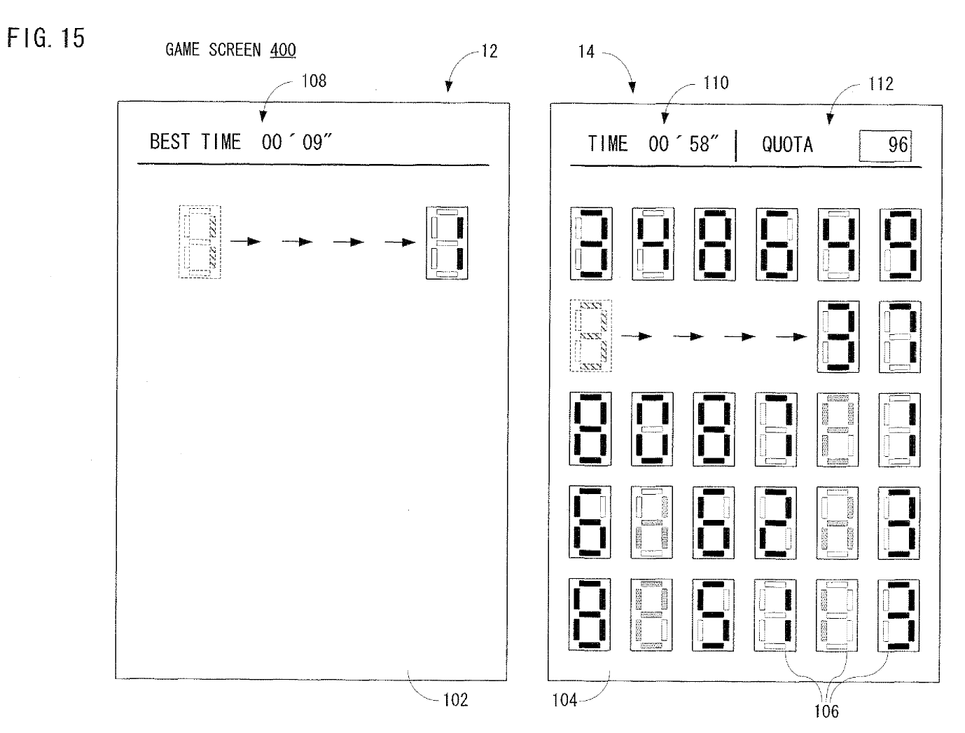

If the sum is equal to the predetermined value, as shown in a game screen 400 of FIG. 15, the piece objects 106 on the two ends and all the piece objects 106 interposed therebetween are erased. That is, the piece objects 106 on the two ends and all the piece objects 106 interposed therebetween are erased from the game screen 400 (the game field 500). When the piece objects 106 are erased, a piece object 106 having a right side where there is an empty grid 502 is shifted rightward in the game screen 400. As shown in FIG. 15, accordingly, a piece object 106 that displays a numeral “3” is shifted rightward in the game screen 400.

Moreover, when the piece objects 106 are erased, a quota is reduced by the number of erased piece objects 106. Herein, the quota displayed on the display area 112 is updated. Herein, a game screen or a sound (an effective sound) indicating success of the erasure of the piece objects 106 may be output. For example, the entire piece objects 106 in the erasure range or only the numerals displayed on all the piece objects 106 in the erasure range are illuminated, and then all the piece objects 106 in the erasure range may be erased. Alternatively, all the piece objects 106 are erased, and then a message indicating success of the erasure may be displayed on the game screen (400).

On the other hand, if the sum is different from the predetermined value, the piece objects 106 on the two ends and all the piece objects 106 interposed therebetween are not erased. As in the case of the failure of the designation of the erasure range, herein, the piece object 106 on the other end (the endpoint) is selected as a first piece object 106m or a piece object 106 on a starting point of a different erasure range. Herein, a game screen or a sound (an effective sound) indicating the failure of the erasure of the piece objects 106 may be output.

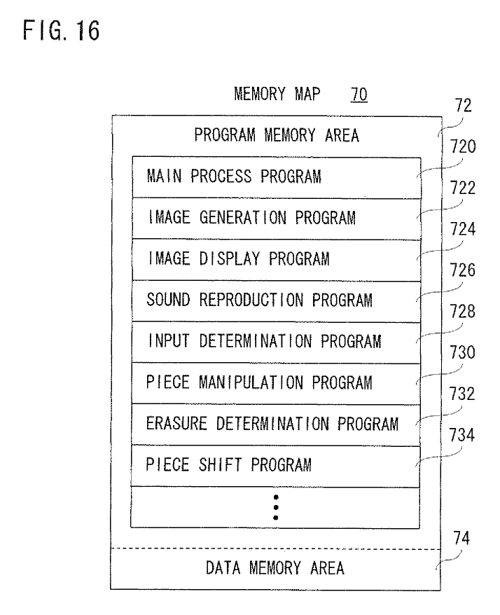

FIG. 16 shows an illustrative view of a memory map 70 in the RAM 42 shown in FIG. 2. As shown in FIG. 16, the RAM 42 includes a program memory area 72 and a data memory area 74. The program memory area 72 stores a puzzle game program, and this puzzle game program is configured with a main process program 720, an image generation program 722, an image display program 724, a sound reproduction program 726, an input determination program 728, a piece manipulation program 730, an erasure determination program 732, a piece shift program 734, and the like.

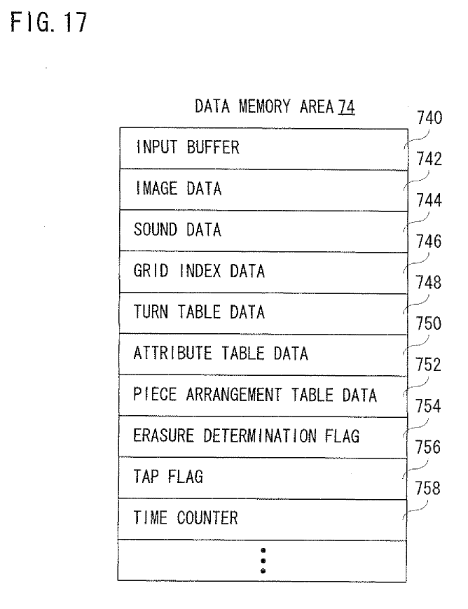

The main process program 720 is a program for processing a main routine of the virtual game (the puzzle game) according to this embodiment. The image generation program 722 is a program for generating a game image for displaying a game screen (100, 150, 200, 250, 300, 350, 400) on the LCDs 12 and 14 by use of image data 742 (see FIG. 17) to be described later. The image display program 724 is a program for displaying the game image generated in accordance with the image generation program 722, as the game screen (100 150, 200, 250, 300, 350, 400) on the LCDs 12 and 14.

The sound reproduction program 726 is a program for reproducing (outputting) a sound required for a game, such as an effective sound and music (BGM), by use of sound data 744 (see FIG. 17) to be described later. The input determination program 728 is a program for determining whether a piece object is in a touch-on state (tap), a touch-off state or a dragging state. For example, a tap flag 762 to be described later is set or cleared in accordance with the input determination program 728. In the touch-off state (a release state), the tap flag 762 is cleared. In the touch-on state (the tap state), on the other hand, the tap flag 762 is set. In a case where coordinate data to be input through the touch panel 24 is changed in the state in which the tap flag 762 is set, an input manipulation is determined as dragging.

The piece manipulation program 730 is a program for selecting a piece object 106, shifting a piece object 106 or changing a display form of a piece object 106, in accordance with a command (an input manipulation) from the player. In this embodiment, a piece object 106 is turned in accordance with the piece manipulation program 730 such that a numeral or the like displayed on the piece object 106 before the turn is symmetrical to a numeral or the like to be displayed on the piece object 106 after the turn, with respect to a line or a point. Thus, the display form of the piece object 106 is changed.

The erasure determination program 732 is a program for determining whether a piece object 106 is erased. In this embodiment, as described above, based on whether a sum of numerals displayed on two or more aligned piece objects 106 selected by the player is equal to a predetermined value, it is determined whether the piece objects 106 are erased.

The piece shift program 734 is a program for supplying a piece object 106, and for shifting rightward, among a plurality of piece objects 106 on the game field 500, a piece object 106 having a right side on the same row where there is an empty grid 502. In this embodiment, a piece object 106 is supplied to a row where the number of piece objects 106 is smallest. If there are a plurality of rows where the number of piece objects 106 is smallest, a piece object 106 is supplied to an upper one of the rows. This is merely one example. Alternatively, a piece object 106 may be supplied at random or in descending order to a row where there is an empty grid 502.

Although not shown in the drawings, the puzzle game program includes a backup program and the like. The backup program is a program for storing (saving) game data (in-progress data or result data) in the RAM 28b of the memory card 28 in accordance with a command from the player or a predetermined game event.

FIG. 17 shows an illustrative view of details of the data memory area 74 shown in FIG. 16. As shown in FIG. 17, the data memory area 74 is provided with an input buffer 740. The input buffer 740 stores (temporarily) coordinate data input through the touch panel 24 in a time-series manner. The coordinate data stored in the input buffer 740 is referred to in an input determination process based on the input determination program 728, or is referred to in order to determine an object (e.g., a piece object 106) designated by the player on the game screen.

Moreover, the data memory area 74 stores image data 742, sound data 744, grid index data 746, turn table data 748, attribute table data 750 and piece arrangement table data 752. Further, the data memory area 74 is provided with an erasure determination flag 754, a tap flag 756 and a time counter 758.

The image data 742 is data such as polygon data or texture data for generating a game image. The sound data 744 is data for generating a sound required for the game or data concerning music (BGM). The grid index data 746 is data storing grid indexes allocated to the respective grids 502 arranged on the game field 500 in correspondence with the respective grids 502. As described above, the grid index is represented by two numerals indicating a row and a column.

The turn table data 748 is data concerning a table providing a pattern (a display pattern) of a numeral or a symbol displayed on a piece object 106 before being turned in correspondence with a display pattern of a numeral or a symbol to be displayed on the piece object 106 after being turned. Herein, the display pattern is represented by seven-digit binary numbers, and the respective digits correspond to segments 106a to 106g in a piece object 106. In this embodiment, the digits from the leftmost one to the rightmost one correspond to the segments 106a, 106b, 106c, 106d, 106e, 106f and 106g, respectively. In each digit, “1” denotes display of a corresponding segment (106a to 106g) whereas “0” denotes non-display of the corresponding segment (106a to 106g).

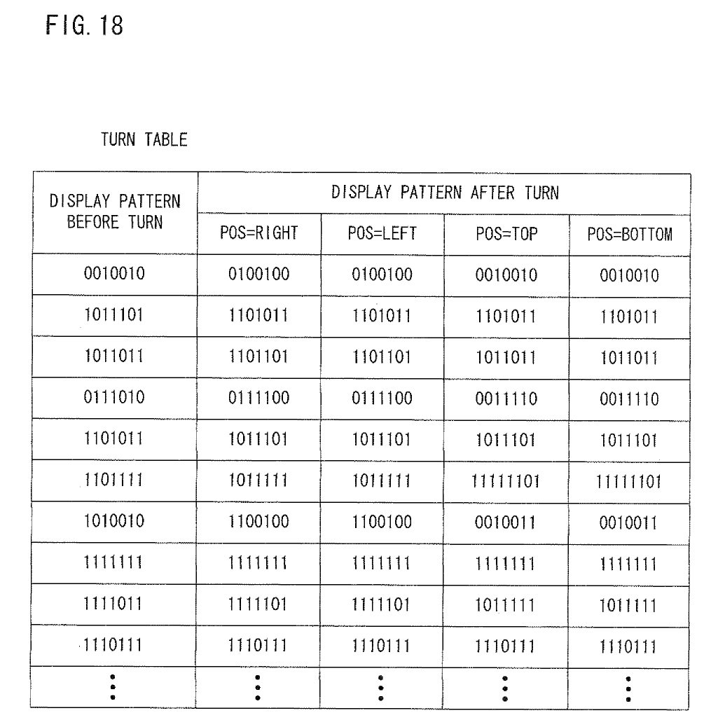

FIG. 18 shows a turn table based on the turn table data 748. In this turn table, display patterns before turn from the uppermost one to the lowermost one correspond to “1”, “2”, “3”, “4”, “5”, “6”, “7”, “8”, “9”, “0” . . . as numerals or symbols. Moreover, display patterns after turn are classified into four display patterns in accordance with a direction of turn. As will be described later, a predetermined value (RIGHT, LEFT, TOP, BOTTOM) corresponds an arrangement position of a second piece object 106n relative to an arrangement position of a first piece object 106m (or a direction of shift of the first piece object 106m), and is input as a variable POS A numeral or a symbol is displayed on a top surface of a turned piece object 106 in accordance with a display pattern after turn based on each predetermined value.

With reference to FIG. 17 again, the attribute table data 750 is data concerning a table providing attributes corresponding the display patterns for display or non-display of the segments 106a to 106g. In this embodiment, a numeral is written as the attribute. Specifically, as shown in FIG. 19(A), an attribute table based on the attribute table data 750 provides a numeral as attribute information written in correspondence with a display pattern. The attribute table is used for determining whether a piece object 106 displays a numeral. Specifically, if the display pattern of the piece object 106 is coincident with the display pattern in the attribute table, it is determined that the piece object 106 displays a numeral. The numeral to be displayed on the piece object 106 is written in correspondence with the coincident display pattern. On the other hand, if the display pattern of the piece object 106 is not coincident with the display pattern in the attribute table, it is determined that the piece object 106 displays a symbol.

With reference to FIG. 17 again, the piece arrangement table data 752 is data concerning a table providing piece information written in correspondence with a grid index. FIG. 19(B) shows a piece arrangement table based on the piece arrangement table data 752. Herein, the piece information denotes information indicating whether a piece object 106 is held in a grid 502 or information indicating a display pattern of the held piece object 106. If no piece object 106 is held in the grid 502, “null” is written as piece information in the grid 502 in correspondence with a grid index indicating the grid 502. On the other hand, if a piece object 106 is held in the grid 502, a display pattern of the piece object 106 is written as piece information in the grid 502 in correspondence with the grid index indicating the grid 502.

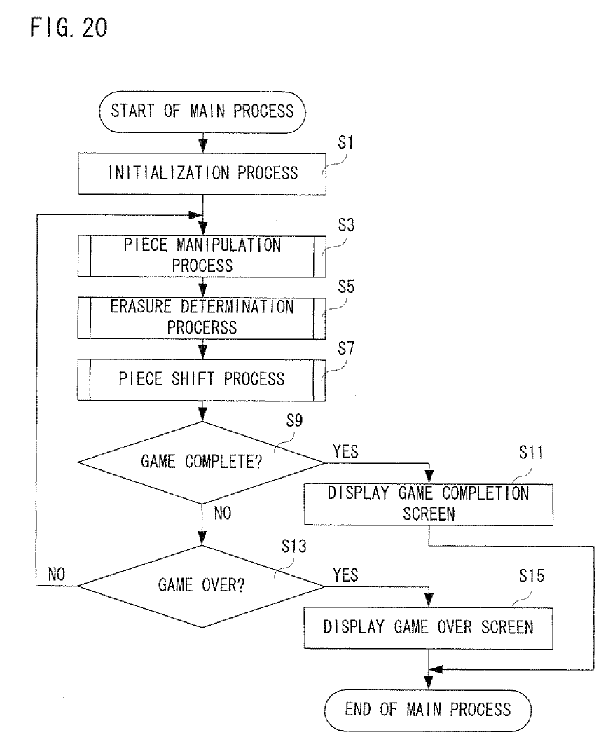

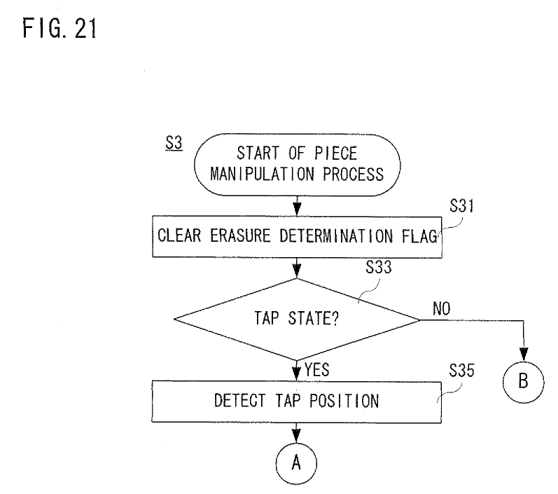

With reference to FIG. 17 again, the erasure determination flag 754 is a flag for determining whether an erasure determination process (FIGS. 20, 27, 28) to be described later is executed. The erasure determination flag 754 is configured with a one-bit register, for example. Upon execution of the erasure determination process, the erasure determination flag 754 is set (ON) and then a data value “1” is stored in the register, Upon execution of no erasure determination process, on the other hand, the erasure determination flag 754 is cleared (OFF) and then a data value “0” is stored in the register, Herein, the erasure determination flag 754 is set or cleared in a piece manipulation process (FIGS. 21 to 26) to be described later.

The tap flag 756 is a flag for determining whether the player taps the stick 26 on the touch panel 24 (touch-on). The tap flag 756 is also configured with a one-bit register. When the player taps the stick 26 on the touch panel 24 (touch-on), the tap flag 756 is set and a data value “1” is stored in the register. On the other hand, when the piayer separates the stick 26 from the touch panel 24 (touch-off), the tap flag 756 is cleared and a data value “0” is stored in the register.

The time counter 758 is a counter (a down counter) for counting a predetermined time. The time counter 758 is used for counting a time interval for supply of a new piece object 106.

Although not shown in the drawings, the data memory area 74 stores another data required for the puzzle game and, further, is provided with another flag or counter (timer) required for the puzzle game.

FIG. 20 shows a flow chart of a main process to be executed by the CPU core 34 shown in FIG. 2. As shown in FIG. 20, the CPU core 34 starts the main process, and in a step S1, the CPU core 34 executes an initialization process. Herein, the CPU core 34 displays the initial screen of the puzzle game. Although not shown in the drawings, in the initial screen, for example, 15 (5 in one row×3 in one column) piece objects 106 are displayed on the right end of the display screen 104 as described above. Moreover, the CPU core 34 nulls variables A, B and C, clears the tap flag 754, and resets and starts the time counter 758. As will be described later in detail, the variable A is a variable for a first piece object 106m or a piece object 106 on an endpoint of an erasure range, the variable B is a variable for a second piece object 106n, and the variable C is a variable for a piece object 106 on a starting point of an erasure range.

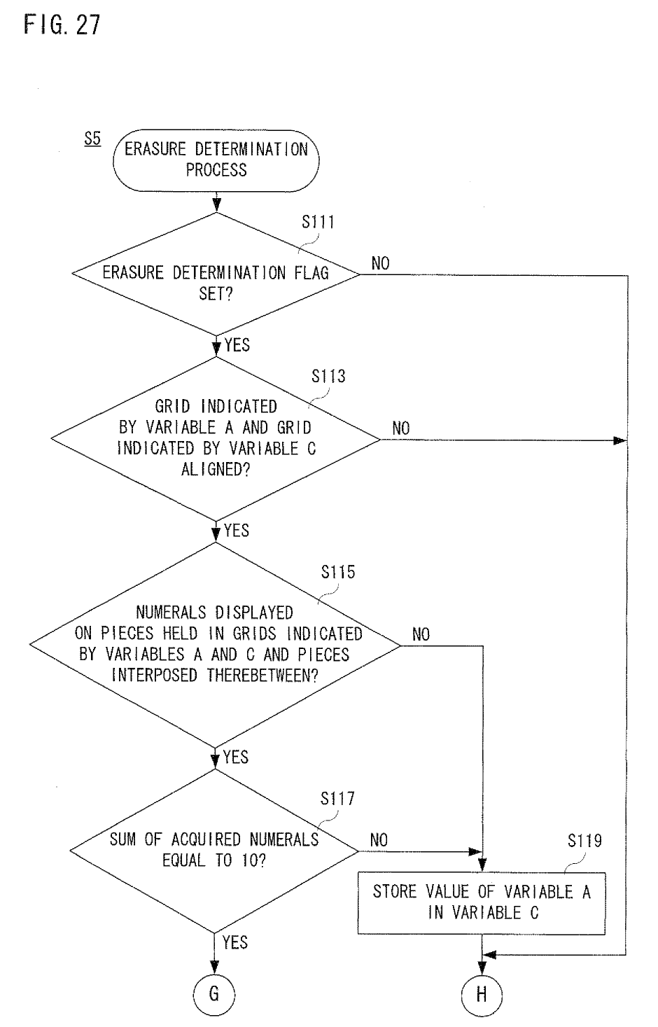

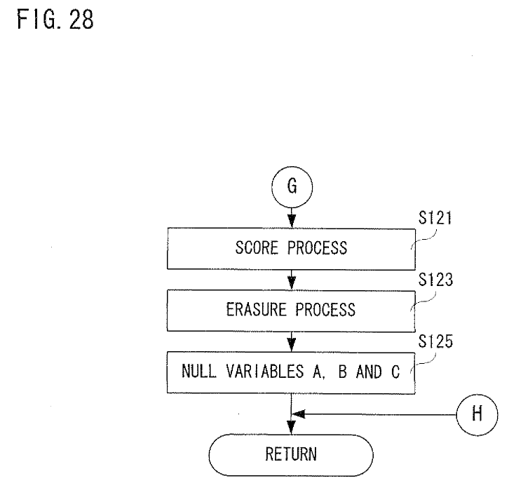

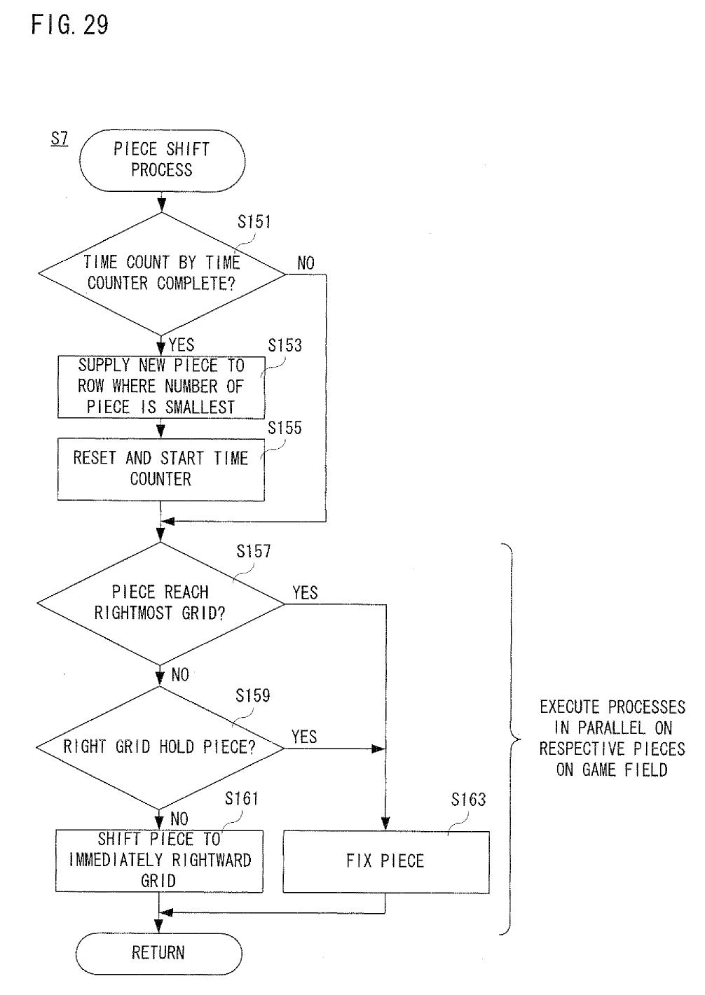

Next, a piece manipulation process (see FIGS. 21 to 26) to be described later is executed in a step S3, an erasure determination process (see FIGS. 27 and 28) to be described later is executed in a step S5, and a piece shift process (see FIG. 29) to be described later is executed in a step S7.

In a step S9, next, it is determined whether a game is complete. In this embodiment, the CPU core 34 determines whether piece objects 106 are erased by a predetermined number set as a quota. If “YES” in the step S9, that is, if the piece objects 106 are erased by the predetermined number set as the quota, it is determined that the game is complete, and, in a step S11, a game completion screen is displayed and the main process is ended.

Although not shown in the drawings, in the game completion screen, for example, a text indicating the game completion is displayed or dramatic production indicating the game completion is effected. Moreover, a sound (a sound effect) or music indicating the game completion may be output in addition to the display of the game completion screen.

On the other hand, if “NO” in the step S9, that is, if the piece objects 106 are not erased by the predetermined number set as the quota, it is determined that the game is not complete, and in a step S13, it is determined whether the game is over. In this embodiment, the CPU core 34 determines whether a limited time is elapsed or piece objects 106 are held in all the grids 502.

Herein, a counter (a timer) (not shown) counts a time elapsed from the start of the game, and it is determined whether a counted value of the timer exceeds the limited time. Moreover, with reference to the piece arrangement table, it is determined whether the piece objects 106 are held in all the grids 502. If each piece information in the piece arrangement table indicates a display pattern, it is determined that all the grids 502 hold the piece objects 106.

If “NO” in the step S13, that is, if the limited time is not exceeded and there is one or more grids 502 holding no piece object 106, it is determined that the game is not over, and then, the processing routine returns to the step S3. On the other hand, if “YES” in the step S13, that is, if the limited time is exceeded or all the grids 502 hold the piece objects 106, it is determined that the game is over, and in a step S15, a game over screen is displayed and the main process is ended.

Although not shown in the drawings, in the game over screen, for example, a text indicating the game over is displayed or dramatic production indicating the game over is effected. Moreover, a sound (a sound effect) or music indicating the game over may be output in addition to the display of the game over screen.

FIGS. 21 to 26 show flow charts of the piece manipulation process in the step S3 shown in FIG. 20. As shown in FIG. 21, the CPU core 34 starts the piece manipulation process, and in a step S31, the erasure determination flag 754 is cleared. In a step S33, next, it is determined whether the touch panel 24 is in the tap state. Herein, the CPU core 34 refers to the input buffer 740 to detect whether coordinate data is input through the touch panel 24, and if the coordinate data in a current frame is input, the tap state is determined, and if no coordinate data in the current frame is input, the release state is determined.

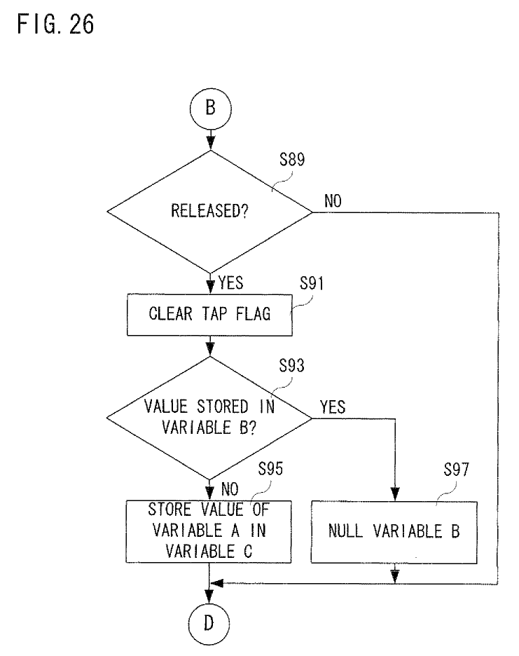

If “NO” in the step S33, that is, if the tap state is not determined, the release state is determined, and the processing routine proceeds to a step S87 (to be described later) shown in FIG. 26. On the other hand, if “YES” in the step S33, that is, if the tap state is determined, a tap position (a touch-on position) is detected in a step S35. In this embodiment, the LCD 14 has resolution equal to detecting precision of the touch panel 24; therefore, use of an identical coordinate system allows use of coordinate data input through the touch panel 24 as coordinate data indicating the tap position on the screen of the LCD 14.

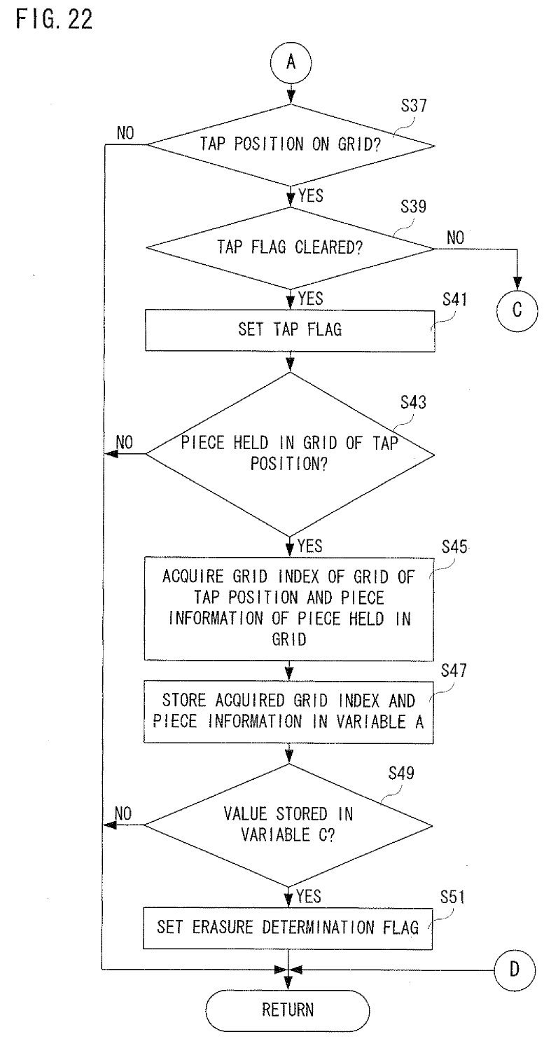

In a step S37 shown in FIG. 22, next, it is determined whether the tap position is on a grid 502. If “NO” in the step S37, that is, if the tap position is out of the grid 502, it is determined that no piece object 106 is designated, and the processing routine returns to the main process. On the other hand, if “YES” in the step S37, that is, if the tap position is on the grid 502, it is determined whether the tap flag 756 is cleared in a step S39. In other words, the CPU core 34 determines whether a change has been made from the release state (the touch-off state) to the tap state (the touch-on state).

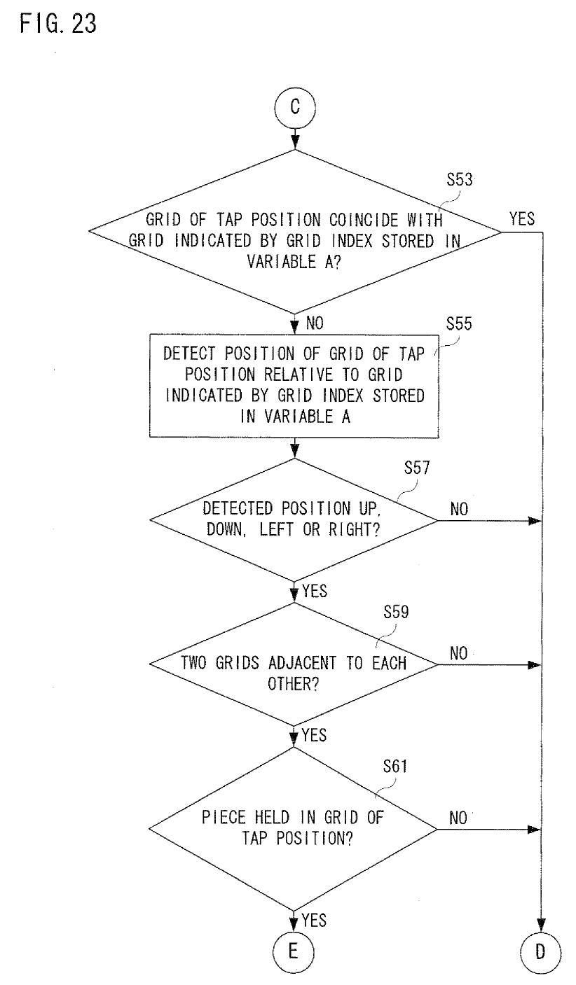

If “NO” in the step S39, that is, if the tap flag 756 is set, it is determined that the tap state is continued, and the processing routine proceeds to a step S53 shown in FIG. 23. On the other hand, if “YES” in the step 839, that is, if the tap flag 756 is cleared, it is determined that a change is made from the release state to the tap state, the tap flag 756 is set in a step S41, and it is determined whether a piece object 106 is held in the grid 502 of the tap position in a step S43. Herein, the CPU core 34 refers to the piece arrangement table data 752 to determine whether “null” is written, as piece information corresponding to a grid index of the grid 502 of the tap position. The same things hold true for the followings.

If “NO” in the step S43, that is, if the “null” is written as the piece information corresponding to the grid index of the grid 502 of the tap position, it is determined that no piece object 106 is held in the grid 502 of the tap position, and the processing routine returns to the main process.

On the other hand, if “YES” in the step S43, that is, if a display pattern is written as the piece information corresponding to the grid index of the grid 502 of the tap position, it is determined that a piece object 106 is held in the grid 502 of the tap position, and in a step S45, the grid index of the grid 502 of the tap position is acquired along with piece information (a display pattern) of the piece object 106 held in the grid 502. In a step S47, next, the grid index and the piece information (the display pattern) each acquired in the step S45 are stored in the variable A. In other words, selection is made of a first piece object 106m or a piece object 106 on an endpoint of an erasure range. For example, the variable A is represented by 14-digit binary numbers, wherein the leading three digits (from a left end) indicate a value of a row number (1 to 5) of the grid index, the subsequent four digits indicate a value of a column number (1 to 12) of the grid index, and the subsequent seven digits indicate a value of a display pattern concerning display and non-display of segments 106a to 106g. The same things hold true for the variables B and C to be described later.

Since, in this embodiment, a piece object 106, which can be selected by the player, is one of piece objects 106 arranged from the sixth column to the twelfth column displayed on the LCD 14, the value of the column number (6 to 12) of the grid index may be represented by three digits.

In a step S49, next, it is determined whether a value is stored in the variable C. Herein, the CPU core 34 determines whether an erasure range is designated by individual tap (touch-on) of two points (piece objects 106). If “NO” in the step S49, that is, if no value is stored in the variable C, the processing routine returns to the main process. On the other hand, if “YES” in the step S49, that is, if the value is stored in the variable C, the erasure determination flag 754 is set in a step S51, and then the processing routine returns to the main process.

As described above, if the tap flag 756 is set, it is determined that the tap state is continued to provide “NO” in the step S39, and it is determined whether the grid 502 of the tap position is coincident with the grid 502 indicated by the grid index stored in the variable A, in the step S53 shown in FIG. 23. That is, the CPU core 34 determines whether the drag is being performed by the player.

If “YES” in the step S53, that is, if the grid 502 of the tap position is coincident with the grid 502 indicated by the grid index stored in the variable A, it is determined that the drag is not being performed by the player, and the processing routine returns to the main process as shown in FIG. 22. On the other hand, if “NO” in the step S53, that is, if the grid 502 of the tap position is not coincident with the grid 502 indicated by the grid index stored in the variable A, it is determines that the drags is being performed by the player, and in a step S55, a position of the grid 502 of the tap position is detected for a case in which a reference is set at the grid 502 indicated by the grid index stored in the variable A. In short, with reference to the grid indexes of the respective grids, a grid 502 having a smaller row number is located at an upper side, while a grid 502 having a larger row number is located at a lower side, and a grid 502 having a smaller column number is located at a left side, while a grid 502 having a larger column number is located at a right side.

In a step S57, next, it is determined whether the position detected in the step S55 is located at any of the upper, lower, left and right sides. If “NO” in the step S57, that is, if the position of the grid 502 of the tap position is located diagonally for a case in which a reference is set at the grid 502 indicated by the grid index stored in the variable A, it is determined that the detected position is not located any of the upper, lower, left and right sides, and the processing routine returns to the main process.

In this embodiment, if “NO” in the step S57, that is, if the drag is made diagonally, the processing routine returns to the main process. Therefore, in a case where the player performs the drag continuously and then a tap is made on on a grid 502 adjacent to the grid 502 vertically or laterally in a subsequent frame, if a piece object 106 is held in the tapped grid 502, the relevant piece object 106 is selected as a second piece object 106n. That is, the drag need not be made linearly.

On the other hand, if “YES” in the step S57, that is, if the position of the grid 502 of the tap position is located at any of the upper, lower, left and right sides for a case in which a reference is made at the grid 502 indicated by the grid index stored in the variable A, it is determined that the detected position is located at any one of the upper, lower, left and right sides, and in a step S59, it is determined whether the two grids 502 are adjacent to each other. Herein, comparison is carried out between row numbers and column numbers of the grid indexes of the two grids 502, respectively, and it is determined whether a sum of absolute values of differences therebetween is “1”. This is because, in the case where the two grids 502 are adjacent to each other, the row number or column number of the grid index in one of the grids 502 is different by “1” from that of the grid index in the other grid 502.

If “NO” in the step S59, that is, if the two grids 502 are not adjacent to each other, the processing routine returns to the main process. On the other hand, if “YES” in the step S59, that is, if the two grids 502 are adjacent to each other, it is determined whether a piece object 106 is held in the grid 502 of the tap position, in a step S61.

If “NO” in the step S61, that is, if “null” is written, as piece information corresponding to the grid index of the grid 502 of the tap position, it is determined that no piece object 106 is held in the grid 502 of the tap position, and the processing routine returns to the main process.

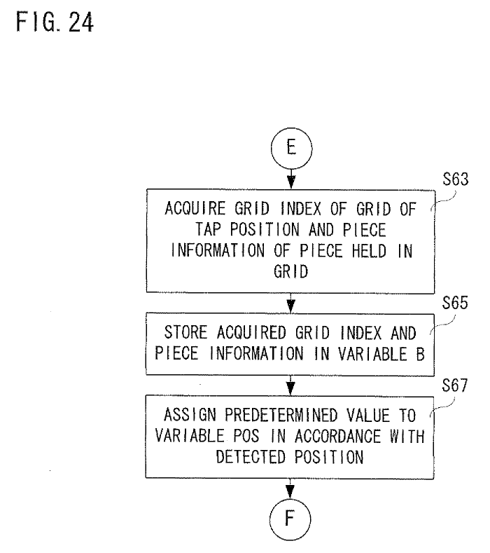

On the other hand, if “YES” in the step S61, that is, if a display pattern is written as the piece information corresponding to the grid index of the grid 502 of the tap position, it is determined that a piece object 106 is held in the grid 502 of the tap position, and in a step S63 shown in FIG. 24, the grid index of the grid 502 of the tap position is acquired along with the piece information (the display pattern) of the piece object 106 held in the grid 502.

If “YES” in the step S55 and the steps S57, S59 and S61, a positional relation is detected between a first piece object 106m and a second piece object 106n.

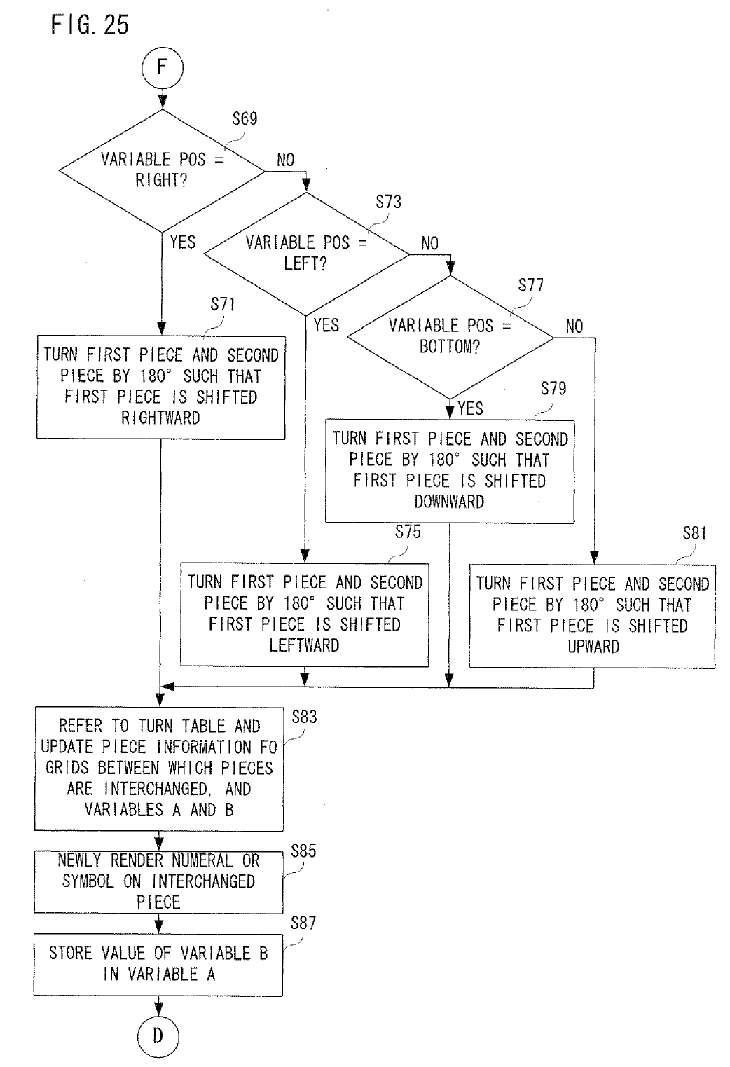

In a step S65, next, the grid index and the piece information (the display pattern) each acquired in the step S63 are stored in the variable B. That is, a second piece object 106n is selected. In a step S67, next, a predetermined value is assigned to the variable POS in accordance with the position detected in the step S55 shown in FIG. 23, and the processing routine proceeds to a step S69 shown in FIG. 25. In the step S67, the CPU core 34 assigns the value “RIGHT” to the variable POS if the detected position is located at the right side, assigns the value “LEFT” to the variable POS if the detected position is located at the left side, assigns the value “TOP” to the variable POS if the detected position is located at the upper side, and assigns the value “BOTTOM” to the variable POS if the detected value is located at the lower side.

In the step S55, if the detected position is located at a diagonal side, the determination in the step S57 is “NO”, and in the step S67, therefore, the value corresponding to the upper, lower, left or right side is assigned to the variable POS without fail.

In the step S69, as shown in FIG. 25, it is determined whether the value “RIGHT” is assigned to the variable POS. If “YES” in the step S69, that is, if the value “RIGHT” is assigned to the variable POS, the first piece object 106m and the second piece object 106n are turned by 180° in a step S71 such that the first piece object 106m shifts rightward, and the processing routine proceeds to a step S83. In the step S71, as shown in FIG. 6(A), the first piece object 106m and the second piece object 106n are turned by 180° about a vertical axis defined therebetween such that the first piece object 106m passes a forward side when being seen from the player whereas the second piece object 106n passes a backward side when being seen from the player.

Although not described in detail, in a case where piece objects 106 are turned, such a state of turn is rendered by a calculation simulation and is displayed on a game screen. As will be described later, the piece objects 106 are turned, then variables A and B are updated, and in accordance therewith, a numeral or a symbol based on a display pattern after the turn is rendered (newly rendered) on a top surface of each piece object 106. In the following, the same things hold true for a case of turning a piece object 106.

If “NO” in the step S69, that is, if the value “RIGHT” is not assigned to the variable POS, it is determined whether the value “LEFT” is assigned to the variable POS, in a step S73. If “YES” in the step S73, that is, if the value “LEFT” is assigned to the variable POS, the first piece object 106m and the second piece object 106n are turned by 180° such that the first piece object 106m shifts leftward, in a step S75, and the processing routine proceeds to the step S83. In the step S75, as shown in FIG. 6(B), the first piece object 106m and the second piece object 106n are turned by 180° about the vertical axis defined therebetween such that the first piece object 106m passes the forward side when being seen from the player whereas the second piece object 106n passes the backward side when being seen from the player.

If “NO” in the step S73, that is, if the value “LEFT” is not assigned to the variable POS, it is determined whether the value “BOTTOM” is assigned to the variable POS, in a step S77. If “YES” in the step S77, that is, if the value “BOTTOM” is assigned to the variable POS, the first piece object 106m and the second piece object 106n are turned by 180° such that the first piece object 1061n shifts downward, in a step S79′ and the processing routine proceeds to the step S83. In the step S79, as shown in FIG. 7(A), the first piece object 106m and the second piece object 106n are turned by 180° about a lateral axis defined therebetween such that the first piece object 106m passes the forward side when being seen from the player whereas the second piece object 106n passes the backward side when being seen from the player.

On the other hand, if “NO” in the step S77, that is, if the value “TOP” is assigned to the variable POS, the first piece object 106m and the second piece object 106n are turned by 180° such that the first piece object 106m shifts upward, in a step S81, and the processing routine proceeds to the step S83. In the step S81, as shown in FIG. 7(B), the first piece object 106m and the second piece object 106n are turned by 180° about the lateral axis defined therebetween such that the first piece object 106m passes the forward side when being seen from the player whereas the second piece object 106n passes the backward side when being seen from the player.

In the step S83, with reference to the turn table, update is made of the piece information of the two grids 502 holding the first piece object 106m and the second piece object 106n the arrangement positions of which are interchanged, as well as of the piece information to be stored in the variables A and B. That is, the display pattern before the turn is changed to the display pattern after the turn with regard to the two grids 502, and the variables A and B. Herein, the display pattern after the turn is determined based on the turn table, in accordance with a predetermined value assigned to the variable POS.

In a step S85, next, the numerals or symbols on the two piece objects 106, the arrangement positions of which are interchanged, are newly rendered. Specifically, since each piece object 106 is reversed because it is turned by 180°, the CPU core 34 newly renders the numeral or the symbol on the top surface of each piece object 106 in accordance with the display pattern after the turn.

In the step S87, next, the value of the variable B is stored in the variable A, and the processing routine returns to the main process as shown in FIG. 22. In the step S87, more specifically, the grid index and the piece information (the display pattern) of the grid 502 holding the shifted first piece object 106m are stored in the variable A. Accordingly, even when the piece object 106 (the first piece object 106m) is continuously shifted based on the dragging by the player, the arrangement position thereof can be interchanged consecutively with that of the adjacent piece object 106 (the second piece object 106n).

As shown in FIG. 21, moreover, if the tap state is not made, “NO” is provided in the step S33, and in a step S89 shown in FIG. 26, a release is determined for. Herein, the CPU core 34 determines whether the tap flag 756 is set. That is, a release is determined in a case where a preceding frame is in the tap state, but a current frame is not in the tap state. Accordingly, a release is not determined in a case where both the preceding frame and the current frame are not in the tap state.

If “NO” in the step S89, that is, if the tap flag 756 is cleared, it is determined that the no touch manipulation is made by the player, and the processing routine returns to the main process as shown in FIG. 22. On the other hand, if “YES” in the step S89, that is, if the tap flag 756 is set, a release is determined, and in a step S91, the tap flag 756 is cleared.

In a step S93, next, it is determined whether a value is stored in the variable B. Herein, the CPU core 34 determines whether the drag has been performed by the player. As described in the step S97, thus, even when a release is made after a drag, a piece object 106 held in a grid 502 designated finally is not selected as a piece object 106 on a starting point of an erasure range.

If “NO” in the step S93, that is, if no value is stored in the variable B, it is determined that the drag has not been made by the player. In a step S95, next, the value of the variable A is stored in the variable C, and the processing routine returns to the main process. That is, a piece object 106 on a starting point is fixed for designating an erasure range. On the other hand, if “YES” in the step S93, that is, if a value is stored in the variable B, it is determined that the drag has made by the player, and in a step S97, the variable B is nullified, and the processing routine returns to the main process. That is, even when a release is made after the drag, a piece object 106 on a starting point is not fixed for designating an erasure range.

FIG. 27 and FIG. 28 show flow charts of the erasure determination process in the step S5 shown in FIG. 20. As shown in FIG. 27, the CPU core 34 starts the erasure determination process and determines, in a step S111, whether the erasure determination flag 754 is set. If “NO” in the step S111, that is, if the erasure determination flag 754 is cleared, it is determined to make no erasure determination, and as shown in FIG. 28, the processing routine returns to the main process. On the other hand, if “YES” in the step S111, that is, if the erasure determination flag 754 is set, it is determined to make an erasure determination, and in a step S113, it is determined whether a grid 502 indicated by the variable A and a grid 502 indicated by the variable C are aligned linearly. Herein, the CPU core 34 refers to the grid index stored in the variable A and the grid index stored in the variable C to determine whether the row numbers or the column numbers thereof are coincident with each other.

If “NO” in the step S113, that is, if either of the row number and the column number is not coincident with their counterpart, it is determined that the grid 502 indicated by the variable A and the grid 502 indicated by the variable C are not aligned linearly, and the processing routine returns to the main process. On the other hand, if “YES” in the step S113, that is, if the row numbers or the column numbers of the grid indexes are coincident with each other, it is determined that the grid 502 indicated by the variable A and the grid 502 indicated by the variable C are aligned linearly, and in a step S115, it is determined whether numerals are displayed on the piece objects 106 held in the grids 502 indicated by the variable A and the variable C and all of piece objects 106 interposed therebetween.

In the step S115, the CPU core 34 refers to the piece arrangement table data 752 to read piece information of the piece object 106 held in the grid 502 each indicated by the variable A and the variable C and piece information of the piece object 106 interposed therebetween.

Herein, the piece information of the piece object 106 interposed between the piece objects 106 held in the grids 502 indicated by the variable A and the variable C, in the following manner. In a case where the row numbers of the grid indexes of the grids 502 indicated by the variable A and the variable C are coincident with each other, acquisition is performed from the piece arrangement table, piece information written in correspondence with grid indexes represented by the relevant row number and column numbers between these grid indexes. On the other hand, in a case where the column numbers of the grid indexes of the grids 502 indicated by the variable A and the variable C are coincident with each other, acquisition is performed from the piece arrangement table, piece information written in correspondence with grid indexes represented by the relevant column number and row numbers between these grid indexes.

Then, the CPU core 34 refers to the attribute table data 750 to acquire an attribute of each piece information read, and determines whether the acquired attribute is a numeral. Herein, if the piece information is “null” or a display pattern other than a numeral, an attribute indicating that a numeral is not displayed is acquired.

If “NO” in the step S115, that is, if any of the acquired attributes indicates a pattern other than a numeral, it is determined that designation of an erasure range results in failure, and in a step S119, the value of the variable A is stored in the variable C. That is, if the designation of the erasure range results in failure, a piece object 106 on an endpoint of the designated erasure range is set as a first piece object 106m or a piece object 106 on a starting point of a subsequent (different) erasure range to be designated next.

On the other hand, if “YES” in the step S115, that is, if all the acquired attributes indicate numerals, respectively, it is determined whether a sum of all the acquired numerals is equal to 10, in a step S117. If “NO” in the step S117, that is, if the sum of all the acquired numerals is different from 10, it is determined that the erasure of the piece objects 106 results in failure (i.e., designation of an erasure range results in failure), and the processing routine proceeds to a step S119. On the other hand, if “YES” in the step S117, that is, if the sum of all the acquired numerals is equal to 10, the erasure of the piece objects 106 is performed successfully, and in a step S121 shown in FIG. 28, a score process is executed. Although not described in detail herein, in this embodiment, the CPU core 34 decrements a numeral set as a quota by the number of piece objects 106 to be erased here, as the score process.

In a step S123, next, an erasure process is executed. As described above, herein, the CPU core 34 illuminates only the numeral on each piece object 106 in the erasure range or entirely illuminates each piece object 106 in the erasure range, and then erases the plurality of piece objects 106 from the game screen (the game field 500). Herein, a sound (a sound effect, music) indicating the state of erasure may be output. Moreover, the plurality of piece objects 106 in the erasure range correspond to the two piece objects 106 held in the grids 502 indicated by the variable A and the variable C, and all the piece objects 106 interposed therebetween.

This erasure process is merely one example, and alternatively, a piece object 106 to be erased may be turned (e.g., 180° turn, 360° turn) on the spot and then may be erased from the game screen. Such dramatic production is a matter determined optionally by a game developer or a game programmer.

In a step S125, next, the variables A, B and C are nullified, and the processing routine returns to the main process.

In this embodiment, if “NO” in the steps S115 and S117, the processing routine proceeds to the step S119; however, dramatic production in a case where designation of an erasure range results in failure or dramatic production in a case where erasure of piece objects 106 results in failure may be performed (e.g., at least one of display of a screen and output of a sound (a sound effect, music) may be performed) before the processing routine proceeds to the step S119.

FIG. 29 shows a flow chart of the piece shift process in the step S7 shown in FIG. 20. As shown in FIG. 29, first, the CPU core 34 starts the piece shift process, and in a step S151, it is determined whether the time counter 758 completes a count of a time. That is, it is determined whether it comes a time to supply a new piece object 106.

If “NO” in the step S157, that is, if the time counter 758 still counts a time, the processing routine proceeds to a step S157. On the other hand, if “YES” in the step S151, that is, if the time counter 758 completes the count of a time, a new piece object 106 is supplied to a grid 502 on a first column in a row where empty space for piece objects 106 is largest, in a step S153. However, if there are a plurality of rows where empty space for piece objects 106 is largest, a new piece object 106 is supplied to a row having a smaller row number (i.e., an upper row).

In a step S155, next, the time counter 758 is reset and started, and the processing routine proceeds to the step S157. That is, by execution of the process in the step S155, count of time is started, which count is carried out for a time interval until a new piece object 106 is supplied next.

In this embodiment, a predetermined time is set to the time counter 758. However, such a predetermined time can be set in a variable manner in accordance with predetermined conditions such as a game level, and a time elapsed from the start of the game. For example, the predetermined time can be made shorter or longer as the game level becomes higher or the time elapsed from the start of the game becomes longer.

In the step S157, next, it is determined whether a target piece object 106 reaches a rightmost grid 502. Herein, the target piece object 106 denotes one piece object 106 or one of a plurality of piece objects 106 on the game field 500. Accordingly, the processes in and subsequent to the step S157 are executed in parallel on each of all the piece objects 106 on the game field 500.

If “YES” in the step S157, that is, if the target piece object 106 reaches the rightmost grid 502, the piece object 106 is fixed at the rightmost grid 502 in a step S163, and the processing routine returns to the main process. Herein, the piece arrangement table is updated, where piece information of the target piece object 106 is stored in the piece arrangement table in correspondence with a grid index of the rightmost grid 502. Moreover, information of “null” is stored in correspondence with a grid index of a grid 502 that originally holds the target piece object 106.

On the other hand, if “NO” in the step S157, that is, if the target piece object 106 does not reach the rightmost grid 502, it is determined whether a piece object 106 is held in a grid 502 adjacent rightward to the grid 502 that holds the target piece object 106, in a step S159.

If “YES” in the step S159, that is, if a piece object 106 is held in the grid 502 adjacent rightward to the grid 502 that holds the target piece object 106, it is determined that the target piece object 106 can not be shifted, and the processing routine proceeds to the step S163. On the other hand, if “NO” in the step S159, that is, if no piece object 106 is held in the grid 502 adjacent rightward to the grid 502 that holds the target piece object 106, it is determined that the target piece object 106 can be shifted, then in a step S161, the target piece object 106 is shifted to the grid 502 adjacent rightward to the grid 502 that originally holds the target piece object 106, and the processing routine returns to the main process. Also in the step S161, the piece arrangement table is updated, where the piece information of the target piece object 106 is stored in correspondence with a grid index of the grid 502 adjacent rightward to the grid 502 that originally holds the target piece object 106. Moreover, the information of “null” is stored in correspondence with the grid index of the grid 502 that originally holds the target piece object 106.

In this embodiment, while the target piece object 106 is shifted to the immediately rightward grid 502, the piece object 106 may be shifted gradually in such a manner that a clearance between the adjacent grids 502 is divided into several segments and a distance that the piece object 106 is shifted in one frame is made short.

According to this embodiment, when an arrangement position of a piece object is changed through drag, a display form of the piece object is also changed. Therefore, the puzzle game gives complexity and fun to the player with simple manipulations.

In this embodiment, a display form of a piece object is changed such that a numeral or a symbol symmetrical to the numeral with respect to a line or a point is displayed on a top surface of the piece object; however, the present invention should not be limited to this configuration.

On a two-dimensional game field, for example, a display form of a piece object is changed such that a numeral or a symbol displayed on the piece object is changed in a line symmetrical manner or a point symmetrical manner; alternatively, on a three-dimensional virtual space, the display form may be changed such that the numeral or the symbol is changed in a plane symmetrical manner.

For example, a letter (e.g., Japanese Hiragana, Japanese Katakana, alphabet) may be displayed on a top surface of a piece object. In such a case, a symbol symmetrical to a letter with respect to a line or a point can be displayed in accordance with shift of a piece object, For example, in a case where a word consisting of two or more letters is established by a letter string written in a plurality of linearly aligned piece objects, the plurality of piece objects can be erased from the game screen.

In a case where a numeral or a letter is displayed on a piece object, moreover, a different numeral or a different letter may be displayed based on a direction of shift or a direction of turn of the piece object.

For example, assuming that a numeral is displayed on a piece object, when the piece object is shifted to a grid adjacent rightward to a grid, the numeral displayed on the piece object is incremented by one, whereas when the piece object is shifted to a grid adjacent leftward to the grid, the numeral displayed on the piece object is decremented by one. Moreover, when the piece object is shifted to a grid adjacent upward to the grid, the numeral displayed on the piece object is incremented by two, whereas when the piece object is shifted to a grid adjacent downward, the numeral displayed on the piece object is decremented by two. In a case where the numeral to be displayed on the piece object is one of “0” to “9”, in accordance with the rule described above, it may be so configured that the piece object that displays the numeral “9” is shifted to the immediately rightward grid, then the numeral is changed to “0”, and that the piece object that displays the numeral “0” is shifted to the immediately leftward grid, then the numeral is changed to “9”. The same things hold true for the case of vertically shifting the piece object.

Further, a piece object may display a graphic, a mark or a specific character (an animation character), in addition to a numeral or a letter. In such a case, a plurality of piece objects each displaying an identical graphic, an identical mark or an identical specific character can be erased when being aligned. Alternatively, a cluster of adjacent piece objects 106 each displaying an identical graphic, an identical mark or an identical specific character can be erased. Also in a case where a predetermined pattern such as a predetermined mark or a predetermined letter is established by arrangement of the plurality of piece objects 106, the plurality of piece objects 106 may be erased, in addition to the case where the plurality of piece objects 106 are aligned linearly or are arranged in a cluster.

Furthermore, a piece object having a color or a design is employed, and the color or the design may be changed based on a direction of shift or a direction of turn of the piece object. In such a case, a plurality of piece objects 106 each having an identical color or an identical design can be erased when being aligned linearly. Alternatively, a cluster of adjacent piece objects 106 each having an identical color or an identical design can be erased.

In addition to the erasure of piece objects displaying an identical graphic, an identical mark or an identical specific character or piece objects having an identical color or an identical design, the number of piece objects to be aligned linearly or the number of clusters of piece objects may be limited.

As described above, in the case where a piece object displays a graphic or the like or in the case where a piece object has a color or a design, it is preferable that a turn table or an attribute table is prepared based thereon. In a case where a letter string is recognized as a word, there is a necessity to prepare data about a word list or a dictionary having assumed words written therein, for erasure determination.

Moreover, in this embodiment, two piece objects to be interchanged are selected by dragging, and a piece object on a starting point and a piece object on an endpoint in an erasure range are selected by individual taps (clicks); however, these manipulations may be exchanged.

In this embodiment, further, since the game field is formed on the three-dimensional virtual space, selected two piece objects are turned, so that arrangement positions thereof are interchanged, but the present invention is not necessarily limited to this configuration. For example, such a virtual space may be a two-dimensional space. In the case where the selected two piece objects are interchanged, these piece objects are not necessarily turned as long as the display forms thereof are changed about an axis defined therebetween after the two piece objects are shifted.

Furthermore, while an erasure range is designated by the player in this embodiment, a plurality of piece objects may be erased automatically when satisfying a predetermined erasure condition in a case where arrangement positions and display forms of two piece objects are changed. Herein, for example, it is determined whether the plurality of piece objects including the piece objects the arrangement positions and the display forms of which are changed satisfy the predetermined erasure condition.

Moreover, this embodiment describes only the case where a piece object displays a numeral or a symbol, but a special function may be allocated to a piece object.

For example, considering that a piece object having a special function allocated thereto is erased, a function to be allocated to the piece object is to erase not only piece objects in an erasure range, but also the piece object having the special function allocated thereto and a piece object adjacent to the erasure range. Moreover, a piece object may have such a function that the piece object can shift only in one direction or such a function that the piece object can not be shifted once being fixed at a grid. Further, a piece object may have such a function that a limited time is prolonged when a piece object having a special function is erased. The piece object having such a special function allocated thereto or a numeral or a symbol to be displayed thereon is different in color from a normal piece object or a piece object having another special function allocated thereto or a numeral or a symbol to be displayed thereon, and the prayer can thus readily identify such a special function.

In this embodiment, further, two piece objects are selected and then arrangement positions thereof are interchanged; however, the present invention is not necessarily limited to this configuration. For example, one piece object is simply shifted to an empty grid, and a display form thereof is changed in accordance with the direction of shift. Specifically, a piece object is reversed laterally when being shifted leftward or rightward, and the piece object is reversed vertically when being shifted upward or downward. Further, the piece object is reversed laterally and vertically when being shifted diagonally. Thus, an arrangement position and a display form of the piece object can be changed.

In this embodiment, further, the touch panel is used as a pointing device. In addition, another pointing device such as a penlight, a pen tablet, a touch pad or a computer mouse may also be employed. In such a case, however, there is a necessity to display a pointing image such as a mouse pointer on a game screen.

However, the present invention is not necessarily limited to the pointing device. For example, a piece object can be selected using a combination of a cursor key and a push button. In such a case, a pointing image such as a cursor is displayed on a game screen, and is shifted using the cursor key. The player presses (turns on) the push button (e.g., the “A” button) in a state in which a desired piece object is designated, thereby selecting the piece object.

Further, the configuration of the game apparatus should not be limited to that described above. For example, the number of LCDs to be provided in the game apparatus may be one. Moreover, a touch panel may be provided on each of two LCDs. Further, a touch panel may be a peripheral device to be connected to the game apparatus.

Furthermore, the game apparatus is not necessarily limited to a portable game apparatus and, for example, may be a portable telephone machine having a game function, a computer having a game function, a stationary game apparatus, an arcade game machine or the like.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A storage medium storing a puzzle game program for a puzzle game apparatus including an inputting means,
said puzzle game program allowing a computer in said puzzle game apparatus to function as:
an arranging means for arranging a plurality of piece objects on a game field;
a selecting means for selecting at least one of the piece objects, based on an input from said inputting means;
an arrangement position changing means for changing an arrangement position of at least one piece object selected by said selecting means, based on an input from said inputting means;
a display form changing means for changing a display form of the piece object having the arrangement position changed by said arrangement position changing means, in accordance with a rule established in advance; and
a condition determining means for determining whether all or part of said plurality of piece objects satisfy a predetermined condition when said display form changing means changes the display form of said piece object.

2. A storage medium storing a puzzle game program according to claim 1, wherein
said puzzle game program further allows said computer to function as a piece erasing means for erasing all or part of said plurality of piece objects from said game field when said condition determining means determines that the predetermined condition is satisfied.

3. A storage medium storing a puzzle game program according to claim 1, wherein
said display form changing means changes the display form of the piece object having the arrangement position changed by said arrangement position changing means such that the display form after being subjected to the change is symmetrical to the display form before being subjected to the change.

4. A storage medium storing a puzzle game program according to claim 1, wherein
said arrangement position changing means interchanges arrangement positions of two piece objects selected by said selecting means.

5. A storage medium storing a puzzle game program according to claim 4, wherein
said inputting means includes a pointing device, and
said selecting means selects a first piece object designated first and a second piece object designated subsequent to the first piece object, the second piece object being adjacent to the first piece object, by use of said pointing device.

6. A storage medium storing a puzzle game program according to claim 1, wherein
said puzzle game apparatus further includes a display form information table storing means for storing display form information table data about the display form of said piece object, and
said display form changing means changes the display form of said piece object in accordance with the display form information table data stored in said display form information table storing means.

7. A storage medium storing a puzzle game program according to claim 1, wherein
said piece object displays a numeral and a symbol that is symmetrical to the numeral, and
said predetermined condition includes a case where a sum of numerals displayed on the plurality of piece objects is equal to a predetermined value.

8. A storage medium storing a puzzle game program according to claim 7, wherein
said puzzle game apparatus further includes an attribute table storing means for storing attribute table data indicating an attribute whether a numeral is displayed in accordance with the display form of said piece object, and
said condition determining means determines whether a sum of numerals displayed on all or part of said plurality of piece objects is equal to the predetermined value, in accordance with the attribute table data stored in said attribute table storing means.

9. A puzzle game apparatus comprising:
an inputting means;
an arranging means for arranging a plurality of piece objects on a game field;
a selecting means for selecting at least one of the piece objects, based on an input from said inputting means;
an arrangement position changing means for changing an arrangement position of at least one piece object selected by said selecting means, based on an input from said inputting means;
a display form changing means for changing a display form of the piece object having the arrangement position changed by said arrangement position changing means, in accordance with a rule established in advance; and
a condition determining means for determining whether all or part of said plurality of piece objects satisfy a predetermined condition when said display form changing means changes the display form of said piece object.

10. A puzzle game control method for a puzzle game apparatus including an inputting means, comprising the steps of:
(a) arranging a plurality of piece objects on a game field;
(b) selecting at least one of the piece objects, based on an input from said inputting means;
(c) changing an arrangement position of at least one piece object selected in said step (b), based on an input from said inputting means;
(d) changing a display form of the piece object having the arrangement position changed in said step (c), in accordance with a rule established in advance; and
(e) determining whether all or part of said plurality of piece objects satisfy a predetermined condition when the display form of said piece object is changed in said step (d).
